(19) United States
(12) Patent Application Publication
(10) Pub. No.: US 2024/0414067 A1
(43) Pub. Date: Dec. 12, 2024

(54) ENHANCED LOADING OF MACHINE LEARNING MODELS IN WIRELESS COMMUNICATIONS

(71) Applicant: Intel Corporation, Santa Clara, CA (US)

(72) Inventor: Yizhi Yao, Chandler, AZ (US)

(73) Assignee: Intel Corporation, Santa Clara, CA (US)

(21) Appl. No.: 18/791,046

(22) Filed: Jul. 31, 2024

Related U.S. Application Data
(60) Provisional application No. 63/517,062, filed on Aug. 1, 2023.

(51) Int. Cl. H04L 41/16; H04L 41/12

(52) U.S. Cl. CPC H04L 41/16; H04L 41/12

(57) ABSTRACT

This disclosure describes systems, methods, and devices for deploying machine learning (ML) models for wireless communications. A Management Service (MnS) Producer apparatus a may include processing circuitry coupled to storage for storing information associated with deploying machine learning (ML) models, the processing circuitry configured to: receive an ML model loading request, or identify an ML model loading policy, defining an ML model and a target inference function to which the ML model is to be loaded; instantiate an ML model loading process to load the ML model to the target inference function, the ML model loading processing comprising a progress status attribute indicative of a progress of loading the ML model to the target inference function; and create a Managed Object Instance (MOI) of the ML model under an MOI of the target inference function based on completion of the loading of the ML model to the target inference function.

### CROSS-REFERENCE TO RELATED PATENT APPLICATION(S)

This application claims the benefit of U.S. Provisional Application No. 63/517,062, filed Aug. 1, 2023, the disclosure of which is incorporated herein by reference as if set forth in full.

### TECHNICAL FIELD

This disclosure generally relates to systems and methods for wireless communications and, more particularly, to loading machine learning models in wireless communications.

### BACKGROUND

Wireless devices are becoming widely prevalent and are increasingly using wireless channels. The 3^{rd} Generation Partnership Program (3GPP) is developing one or more standards for wireless communications.

### BRIEF DESCRIPTION OF THE DRAWINGS

FIG. 1 is an example artificial intelligence/machine learning operational workflow, in accordance with one or more example embodiments of the present disclosure.

FIG. 2 is an example functional overview and service framework for machine learning training, in accordance with one or more example embodiments of the present disclosure

FIG. 3 illustrates example machine learning training requested by a management system consumer, in accordance with one or more example embodiments of the present disclosure

FIG. 4 shows an example testing request and reporting procedure, in accordance with one or more embodiments of the present disclosure.

FIG. 5 shows example a network resource model fragment for machine learning entity loading, in accordance with one or more embodiments of the present disclosure.

FIG. 6 shows an example inheritance hierarchy for machine learning entity loading related network resource models, in accordance with one or more embodiments of the present disclosure.

FIG. 7 depicts an example network architecture, in accordance with one or more example embodiments of the present disclosure.

FIG. 8 schematically illustrates a wireless network, in accordance with one or more example embodiments of the present disclosure.

FIG. 9 illustrates components capable of reading instructions from a machine-readable or computer-readable medium, in accordance with one or more example embodiments of the present disclosure.

FIG. 10 illustrates an example cellular network, in accordance with one or more example embodiments of the present disclosure.

FIG. 11 shows example network deployments including an example next generation fronthaul (NGF) deployment, in accordance with one or more example embodiments of the present disclosure.

FIG. 12 depicts an example of management services (MnS) deployment, in accordance with one or more example embodiments of the present disclosure.

FIG. 13 shows an example framework of provisioning MnS, in accordance with one or more example embodiments of the present disclosure.

FIG. 14 depicts an example AI/ML-assisted communication network, in accordance with one or more embodiments of the present disclosure.

FIG. 15 illustrates an example neural network, in accordance with one or more embodiments.

FIG. 16 shows an RL architecture, in accordance with one or more embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless devices may operate as defined by technical standards. For cellular telecommunications, the 3rd Generation Partnership Program (3GPP) defines communication techniques, including use of artificial intelligence (AI)/machine learning (ML) techniques.

During a ML entity (also referred to as ML model) training phase, after the training and validation, the ML entity needs to be tested to evaluate the performance of the ML entity when it conducts inference using the testing data. Testing may involve interaction with third parties (e.g., in addition to the developer of the ML training function), and the operators may use the ML training function or third-party systems/functions that may rely on the inference results computed by the ML entity for testing.

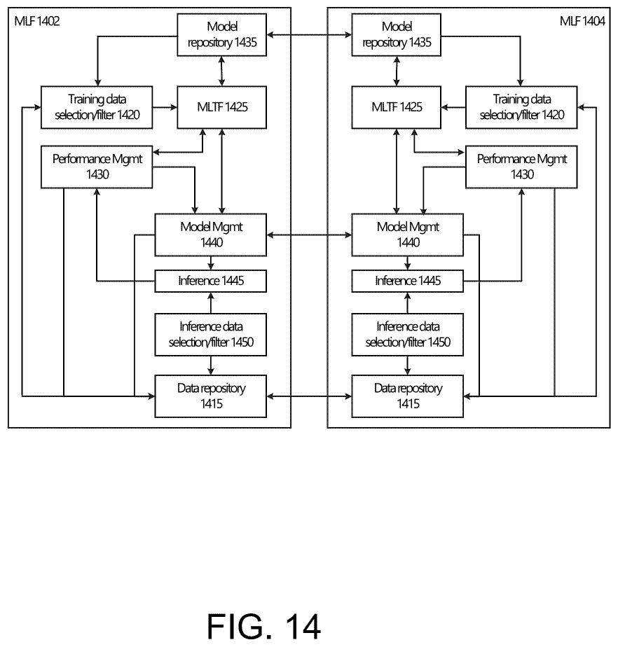

After a trained ML entity meets predefined and/or configured performance criteria per the ML entity testing and/or ML emulation, the ML entity could be loaded in target inference function(s) (e.g., an inference function 1445 of FIG. 14) in the system. ML entity loading refers to the process of making an ML entity available in the system (e.g., NFs and/or management functions (MnFs)), where it could start conducting inference. Some ways for loading the ML entity is/are vendor specific, which could be software installation, file transfer, or configuration management procedure, etc. However, the management service (MnS) producer (MnS-P) responsible for ML entity loading should provide a capability for MnS consumer (MnS-C) to manage the ML entity loading.

After a trained ML entity is tested and optionally emulated, if the performance of the ML entity meets the MnS consumer's requirements, the MnS consumer may request the producer to load the ML entity to one or more target inference function(s) where the ML entity will be used for conducting inference.

In some examples, the ML entity loading MnS-P may be separate from or co-located with the MnS-P of the inference function or training function.

Once the ML entity loading request is accepted, the MnS consumer needs to know the progress of the loading and needs to be able to control (e.g., cancel, suspend, resume) the loading process. For a completed ML entity loading, the ML entity instance loaded to each target inference function needs to be manageable individually, for instance, to be activated individually or concurrently.

To enable more autonomous AI/ML operations, the MnS-P is allowed to load the ML entity to the target inference function(s) without the consumer's specific request.

In this case, the consumer needs to be able to set the policy for the ML loading, to make sure that ML entities loaded by the MnS-P meet the performance target. The policy could be, for example, the threshold of the testing performance of the ML entity, the threshold of the inference performance of the existing ML model, the time schedule allowed for ML entity loading, etc.

ML models are typically trained and tested to meet specific requirements for inference, addressing a specific use case or task. The network conditions may change regularly, for example, the gNB providing coverage for a specific location is scheduled to accommodate different load levels and/or patterns of services at different times of the day, or on different days in a week. A dedicated ML entity may be loaded per the policy to adapt to a specific load/traffic pattern.

Table 1 below shows imported information entities and local labels for information models for ML entity loading (e.g., deployment):

TABLE 1
Imported Information Entities and Local Labels

| Label reference | Local label |
|---|---|
| 3GPP TS 28.622, IOC, Top | Top |
| 3GPP TS 28.622, IOC, SubNetwork | SubNetwork |
| 3GPP TS 28.622, IOC, ManagedElement | ManagedElement |
| 3GPP TS 28.622, IOC, ManagedFunction | ManagedFunction |

Table 2 below shows associated information entities and local labels for information models for ML entity loading:

TABLE 2
Imported Information Entities and Local Labels

| Label reference | Local label |
|---|---|
| 3GPP TS 28.104, IOC, MDAFunction | MDAFunction |
| 3GPP TS 28.541, IOC, NWDAFFunction | NWDAFFunction |

An IOC entity referred to as MLEntity may represent the ML entity, and may include multiple types of contexts: (1) TrainingContext, which is the context under which the MLEntity has been trained; (2) ExpectedRunTimeContext, which is the context where an MLEntity is expected to be applied; and/or (3) RunTimeContext, which is the context where the MLEntity is being applied. Table 3 below includes attributes for an MLEntity:

TABLE 3
MLEntity Attributes

| | Support | | | | |
|---|---|---|---|---|---|
| | Qualifier | isReadable | isWritable | isInvariant | isNotifyable |
| Attribute name | | | | | |
| mLEntityId | M | T | F | F | T |
| inferenceType | M | T | F | F | T |
| mLEntityVersion | M | T | F | F | T |
| expectedRunTimeContext | O | T | F | F | T |
| trainingContext | CM | T | F | F | T |
| runTimeContext | O | T | F | F | T |
| Attribute related to role | | | | | |
| trainedMLEntityLoadedRef | CM | T | F | F | T |

Table 4 below shows attribute constraints for the MLEntity attributes of Table 3:

TABLE 4
MLEntity Attribute Constraints

| Name | Definition |
|---|---|
| trainingContext Support | Condition: The trainingContext represents |
| Qualifier | the status and conditions related to training |
| | and should be added when training is |
| | completed. |
| trainedMLEntityLoadedRef | Condition: The MLEntity MOI containing |
| Support Qualifier | this attribute represents an ML entity loaded |
| | to an inference function. |

MLEntityLoadingRequest may be an IOC representing the ML entity loading request created by the MnS consumer. Using this IOC, the MnS consumer requests the MnS producer responsible for ML entity loading to load an ML entity to the one or more targer inference functions. The MLEntityLoadingRequest IOC may include a requestStatus field to represent the status of the request: (a) The attribute values are “NOT_STARTED”, “LOADING_IN_PROGRES”, “SUSPENDED”, “FINISHED”, and “CANCELLED”. (b) When value turns to “LOADING_IN_PROGRESS”, the MnS producer instantiates one or more MLEntityLoadingProcess MOI(s) (Managed Object Instances) representing the loading process(es) being performed per the request and notifies the MnS consumer(s) who subscribed to the notification. When all of the loading process(es) associated to this request are completed, the value turns to “FINISHED”.

Table 5 below shows attributes of the MLEntityLoadingRequest IOC:

TABLE 5
Attributes of MLEntityLoadingRequest

| | Support | | | | |
|---|---|---|---|---|---|
| | Qualifier | isReadable | isWritable | isInvariant | isNotifyable |
| Attribute name | | | | | |
| requestStatus | M | T | T | F | T |
| cancelRequest | O | T | T | F | T |
| suspendRequest | O | T | T | F | T |
| Attribute related to role | | | | | |
| mLEntityToLoadRef | M | T | F | F | T |
| targetInferfenceFunctionsRef | M | T | F | F | T |

There may not be any constraints to the attributes in Table 5.

An MLEntityLoadingPolicy IOC may represent the ML entity loading policy set by the MnS consumer to the producer for loading an ML entity to the target inference function(s). This IOC may be used for the MnS consumer to set the conditions for the producer-initiated ML entity loading. The MnS producer may only be allowed to load the ML entity when all of the conditions are satisfied.

Table 6 below shows attributes of the MLEntityLoadingPolicy IOC:

TABLE 6
Attributes of MLEntityLoadingPolicy

| | Support | | | | |
|---|---|---|---|---|---|
| | Qualifier | isReadable | isWritable | isInvariant | isNotifyable |
| Attribute name | | | | | |
| inferenceType | CM | T | T | F | T |
| mLEntityId | CM | T | T | F | T |
| thresholdMLEntityToLoad | M | T | T | F | T |
| thresholdMLEntityExisting | M | T | T | F | T |
| allowedTimeWindows | O | T | T | F | T |
| Attribute related to role | | | | | |
| targetInferfenceFunctions | CM | T | T | F | T |

Table 7 below shows attribute constraints for the MLEntityLoadingPolicy IOC:

TABLE 7
MLEntityLoadingPolicy Attribute Constraints

| Name | Definition |
|---|---|
| inferenceType Support | Condition: The ML entity loading policy is |
| Qualifier | related to an initially trained ML entity. |
| mLEntityId Support | Condition: The ML entity loading policy is |
| Qualifier | related to a retrained ML entity. |

An MLEntityLoadingProcess IOC represents the ML entity loading process. For the consumer-requested ML entity loading, one or more MLEntityLoadingProcess MOIs may be instantiated for each ML entity loading request presented by the MLEntityLoadingRequest MOI.

For the producer-initiated ML entity loading, one or more MLEntityLoadingProcess MOI(s) may be instantiated and associated with each MLEntityLoadingPolicy MOI.

One MLEntityLoadingProcess MOI represents the ML entity loading process(es) corresponding to one or more target inference function(s).

The “progressStatus” attribute represents the status of the ML entity loading process and includes information the MnS consumer can use to monitor the progress and results. The data type of this attribute is “ProcessMonitor” (see 3GPP TS 28.622). The following specializations are provided for this data type for the ML entity loading process:
The “status” attribute values are “RUNNING”, “CANCELLING”, “SUSPENDED”, “FINISHED”, and “CANCELLED”. The other values are not used.
The “timer” attribute is not used.
When the “status” is equal to “RUNNING” the “progressStateInfo” attribute shall indicate one of the following state: “LOADING”.
No specifications are provided for the “resultStateInfo” attribute. Vendor specific information may be provided though.

When the loading is completed with “status” equal to “FINISHED”, the MnS producer creates the MOI(s) of loaded MLEntity under each MOI of the target inference function(s).

Table 8 below shows attributes of the MLEntityLoadingProcess IOC:

TABLE 8
Attributes of MLEntityLoadingProcess

| | Support | | | | |
|---|---|---|---|---|---|
| | Qualifier | isReadable | isWritable | isInvariant | isNotifyable |
| Attribute name | | | | | |
| progressStatus | M | T | F | F | T |
| cancelProcess | O | T | T | F | T |
| suspendProcess | O | T | T | F | T |
| Attribute related to role | | | | | |
| MLEntityLoadingRequestRef | CM | T | F | F | T |
| targetInferenceFunctionsRef | M | T | F | F | T |
| MLEntityLoadingPolicyRef | CM | T | F | F | T |

Table 9 below shows attribute constraints for the MLEntityLoadingProcess attributes:

TABLE 9
MLEntityLoadingPolicy Attribute Constraints

| Name | Definition |
|---|---|
| MLEntityLoadingRequestRef | Condition: The MLEntityLoadingProcess |
| Support Qualifier | MOI is corresponding to the ML entity |
| | loading requested by the MnS consumer. |
| MLEntityLoadingPolicyRef | Condition: The MLEntityLoadingProcess |
| Support Qualifier | MOI is corresponding to the ML entity |
| | loading initiated by the MnS producer. |

A <<dataType>> ThresholdInfo is a data type representing the information of a threshold. Table 10 below shows attributes of the ThresholdInfo data type:

TABLE 10
Attributes of ThresholdInfo

| | Support | | | | |
|---|---|---|---|---|---|
| Attribute name | Qualifier | isReadable | isWritable | isInvariant | isNotifyable |
| performanceMetricName | M | T | T | F | T |
| thresholdDirection | M | T | T | F | T |
| thresholdValue | M | T | T | F | T |

There may be no attribute constraints on the ThresholdInfo attributes.

A <<dataType>> TimeWindow may be a data type representing a time window. Table 11 below shows attributes of the TimeWindow data type:

TABLE 11
Attributes of TimeWindow

| Attribute | Support | | | | |
|---|---|---|---|---|---|
| name | Qualifier | isReadable | isWritable | isInvariant | isNotifyable |
| startTime | CM | T | F | F | F |
| stopTime | M | T | F | F | F |

There may be no attribute constraints for the TimeWindow attributes.

A <<dataType>> WeeklyTimeWindow may be a data type representing a time window. Table 12 below shows attributes of WeeklyTimeWindow:

TABLE 12
Attributes of WeeklyTimeWindow

| | Support | | | | |
|---|---|---|---|---|---|
| Attribute name | Qualifier | isReadable | isWritable | isInvariant | isNotifyable |
| dayOfWeek | M | T | T | F | F |
| dailyTimeWindows | M | T | F | F | F |

There may be no attribute constraints to the WeeklyTimeWindow attributes.

Table 13 below shows attribute properties of the above attributes:

TABLE 13
Attribute Properties of Above Attributes

| Attribute Name | Documentation and Allowed Values | Properties |
|---|---|---|
| mLEntityId | It identifies the ML entity. | type: String |
| | It is unique in each MnS producer. | multiplicity: 1 |
| | allowedValues: N/A. | isOrdered: N/A |
| | | isUnique: N/A |
| | | defaultValue: None |
| | | isNullable: True |
| candidateTrainingDataSource | It provides the address(es) of the candidate | type: String |
| | training data source provided by MnS | multiplicity: * |
| | consumer. The detailed training data format is | isOrdered: False |
| | vendor specific. | isUnique: True |
| | allowedValues: N/A. | defaultValue: None |
| | | isNullable: True |
| inferenceType | It indicates the type of inference that the ML | type: String |
| | model supports. | multiplicity: 1 |
| | allowedValues: the values of the MDA type | isOrdered: N/A |
| | (see 3GPP TS 28.104 [2]), Analytics ID(s) of | isUnique: N/A |
| | NWDAF (see 3GPP TS 23.288 [3]), types of | defaultValue: None |
| | inference for RAN-intelligence, and vendor's | isNullable: True |
| | specific extensions. | |
| areConsumerTrainingDataUsed | It indicates whether the consumer provided | type: Enum |
| | training data have been used for the ML model | multiplicity: 1 |
| | training. | isOrdered: N/A |
| | allowedValues: ALL, PARTIALLY, NONE. | isUnique: N/A |
| | | defaultValue: None |
| | | isNullable: True |
| usedConsumerTrainingData | It provides the address(es) where lists of the | type: String |
| | consumer-provided training data are located, | multiplicity: * |
| | which have been used for the ML model | isOrdered: False |
| | training. | isUnique: True |
| | allowedValues: N/A. | defaultValue: None |
| | | isNullable: True |
| trainingRequestRef | It is the DN(s) of the related | type: DN (see TS |
| | MLTrainingRequest MOI(s). | 32.156 [13]) |
| | allowedValues: DN. | multiplicity: * |
| | | isOrdered: False |
| | | isUnique: True |
| | | defaultValue: None |
| | | isNullable: True |
| trainingProcessRef | It is the DN(s) of the related | type: DN (see TS |
| | MLTrainingProcess MOI(s) that produced the | 32.156 [13]) |
| | MLTrainingReport. | multiplicity: 1 |
| | allowedValues: DN. | isOrdered: N/A |
| | | isUnique: N/A |
| | | defaultValue: None |
| | | isNullable: True |
| trainingReportRef | It is the DN of the MLTrainingReport MOI | type: DN (see |
| | that represents the reports of the ML training. | TS 32.156 [13]) |
| | allowedValues: DN. | multiplicity: 1 |
| | | isOrdered: N/A |
| | | isUnique: N/A |
| | | defaultValue: None |
| | | isNullable: True |
| lastTrainingRef | It is the DN of the MLTrainingReport MOI | type: DN (see 3GPP |
| | that represents the reports for the last training | TS 32.156 [13]) |
| | of the ML model. | multiplicity: 1 |
| | allowedValues: DN. | isOrdered: N/A |
| | | isUnique: N/A |
| | | defaultValue: None |
| | | isNullable: True |
| confidenceIndication | It indicates the confidence (in unit of | type: integer |
| | percentage) that the ML model would perform | multiplicity: 1 |
| | for inference on the data with the same | isOrdered: N/A |
| | distribution as training data. | isUnique: N/A |
| | allowedValues: {0 . . . 100}. | defaultValue: None |
| | | isNullable: False |
| mLEntityList | It describes the list of MLEntity. | type: MLEntity |
| | | multiplicity: * |
| | | isOrdered: False |
| | | isUnique: True |
| | | defaultValue: None |
| | | isNullable: False |
| trainingRequestSource | It describes the entity that requested to | type: String |
| | instantiate the MLTrainingRequest MOI. | multiplicity: 1 |
| | | isOrdered: N/A |
| | | isUnique: N/A |
| | | defaultValue: None |
| | | isNullable: False |
| MLTrainingRequest.requestStatus | It describes the status of a particular ML | type: Enum |
| | training request. | multiplicity: 1 |
| | allowedValues: NOT_STARTED, | isOrdered: N/A |
| | TRAINING_IN_PROGRESS, | isUnique: N/A |
| | CANCELLING, SUSPENDED, FINISHED, | defaultValue: None |
| | and CANCELLED. | isNullable: False |
| mLTrainingProcessId | It identifies the training process. | type: String |
| | It is unique in each instantiated process in the | multiplicity: 1 |
| | MnS producer. | isOrdered: N/A |
| | allowedValues: N/A. | isUnique: N/A |
| | | defaultValue: None |
| | | isNullable: True |
| priority | It indicates the priority of the training process. | type: integer |
| | The priority may be used by the ML training | multiplicity: 1 |
| | to schedule the training processes. Lower | isOrdered: N/A |
| | value indicates a higher priority. | isUnique: N/A |
| | allowedValues: {0 . . . 65535}. | defaultValue: 0 |
| | | isNullable: False |
| terminationConditions | It indicates the conditions to be considered by | type: String |
| | the MLtraining MnS producer to terminate a | multiplicity: 1 |
| | specific training process. | isOrdered: N/A |
| | allowed Values: MODEL | isUnique: N/A |
| | UPDATED_IN_INFERENCE_FUNCTION, | defaultValue: None |
| | INFERENCE FUNCTION_TERMINATED, | isNullable: False |
| | INFERENCE FUNCTION_UPGRADED, | |
| | INFERENCE_CONTEXT_CHANGED. | |
| progressStatus | It indicates the status of the process. | type: |
| | allowedValues: N/A. | ProcessMonitor |
| | | (see TS 28.622 |
| | | [12]) |
| | | multiplicity: 1 |
| | | isOrdered: N/A |
| | | isUnique: N/A |
| | | defaultValue: None |
| | | isNullable: False |
| mLEntityVersion | It indicates the version number of the ML | type: String |
| | entity. | multiplicity: 1 |
| | allowedValues: N/A. | isOrdered: N/A |
| | | isUnique: N/A |
| | | defaultValue: None |
| | | isNullable: False |
| performanceRequirements | It indicates the expected performance for a | type: |
| | trained ML entity when performing on the | ModelPerformance |
| | training data. | multiplicity: * |
| | allowedValues: N/A. | isOrdered: False |
| | | isUnique: True |
| | | defaultValue: None |
| | | isNullable: True |
| modelperformanceTraining | It indicates the performance score of the ML | type: |
| | entity when performing on the training data. | ModelPerformance |
| | allowedValues: N/A. | multiplicity: * |
| | | isOrdered: False |
| | | isUnique: True |
| | | defaultValue: None |
| | | isNullable: False |
| mLTrainingProcess.progressStatus.progressStateInfo | It provides the following specialization for the | Type: String |
| | “progressStateInfo” attribute of the | multiplicity: 0 . . . 1 |
| | “ProcessMonitor” data type for the | isOrdered: N/A |
| | “MLTrainingProcess”. | isUnique: N/A |
| | When the ML training is in progress, and the | defaultValue: None |
| | “mLTrainingProcess.progressStatus.status” is | isNullable: False |
| | equal to “RUNNING”, it provides the more | |
| | detailed progress information. | |
| | allowedValues for | |
| | “mLTrainingProcess.progressStatus.status” = | |
| | “RUNNING”: | |
| | COLLECTING_DATA | |
| | PREPARING_TRAINING_DATA | |
| | TRAINING | |
| | The allowed values for | |
| | “mLTrainingProcess.progressStatus.status” = | |
| | “CANCELLED” are vendor specific. | |
| inferenceOutputName | It indicates the name of an inference output of | Type: String |
| | an ML entity. | multiplicity: 1 |
| | allowedValues: the name of the MDA output | isOrdered: N/A |
| | IEs (see 3GPP TS 28.104 [2]), name of | isUnique: N/A |
| | analytics output IEs of NWDAF (see TS | defaultValue: None |
| | 23.288 [3]), RAN-intelligence inference | isNullable: False |
| | output IE name(s), and vendor's specific | |
| | extensions. | |
| performanceMetric | It indicates the performance metric used to | Type: String |
| | evaluate the performance of an ML entity, e.g. | multiplicity: 1 |
| | “accuracy”, “precision”, “F1 score”, etc. | isOrdered: N/A |
| | allowedValues: N/A. | isUnique: True |
| | | defaultValue: None |
| | | isNullable: False |
| performanceScore | It indicates the performance score (in unit of | Type: Real |
| | percentage) of an ML entity when performing | multiplicity: 1 |
| | inference on a specific data set (Note). | isOrdered: N/A |
| | The performance metrics may be different for | isUnique: N/A |
| | different kinds of ML models depending on | defaultValue: None |
| | the nature of the model. For instance, for | isNullable: False |
| | numeric prediction, the metric may be | |
| | accuracy; for classification, the metric may be | |
| | a combination of precision and recall, like the | |
| | “F1 score”. | |
| | allowedValues: {0 . . . 100}. | |
| MLTrainingRequest.cancelRequest | It indicates whether the ML training MnS | Type: Boolean |
| | consumer cancels the ML training request. | multiplicity: 0 . . . 1 |
| | Setting this attribute to “TRUE” cancels the | isOrdered: N/A |
| | ML training request. Cancellation is possible | isUnique: N/A |
| | when the requestStatus is the | defaultValue: |
| | “NOT_STARTED”, | FALSE |
| | “TRAINING_IN_PROGRESS”, and | isNullable: False |
| | “SUSPENDED” state. Setting the attribute to | |
| | “FALSE” has no observable result. | |
| | Default value is set to “FALSE”. | |
| | allowedValues: TRUE, FALSE. | |
| MLTrainingRequest.suspendRequest | It indicates whether the ML training MnS | Type: Boolean |
| | consumer suspends the/ML training request. | multiplicity: 0 . . . 1 |
| | Setting this attribute to “TRUE” suspends the | isOrdered: N/A |
| | ML training request. Suspension is possible | isUnique: N/A |
| | when the requestStatus is not the “FINISHED” | defaultValue: |
| | state. Setting the attribute to “FALSE” has no | FALSE |
| | observable result. | isNullable: False |
| | Default value is set to “FALSE”. | |
| | allowedValues: TRUE, FALSE. | |
| MLTrainingProcess.cancelProcess | It indicates whether the ML training MnS | Type: Boolean |
| | consumer cancels the ML training process. | multiplicity: 0 . . . 1 |
| | Setting this attribute to “TRUE” cancels the | isOrdered: N/A |
| | ML training request. Cancellation is possible | isUnique: N/A |
| | when the | defaultValue: |
| | “mLTrainingProcess.progressStatus.status” is | FALSE |
| | not the “FINISHED” state. Setting the attribute | isNullable: False |
| | to “FALSE” has no observable result. | |
| | Default value is set to “FALSE”. | |
| | allowedValues: TRUE, FALSE. | |
| MLTrainingProcess.suspendProcess | It indicates whether the ML training MnS | Type: Boolean |
| | consumer suspends the ML training process. | multiplicity: 0 . . . 1 |
| | Setting this attribute to “TRUE” suspends the | isOrdered: N/A |
| | ML training request. Suspension is possible | isUnique: N/A |
| | when the | defaultValue: |
| | “mLTrainingProcess.progressStatus.status” is | FALSE |
| | not the “FINISHED”, “CANCELLING” or | isNullable: False |
| | “CANCELLED” state. Setting the attribute to | |
| | “FALSE” has no observable result. | |
| | Default value is set to “FALSE”. | |
| | allowedValues: TRUE, FALSE. | |
| inferenceEntityRef | It describes the target entities that will use the | Type: DN (see |
| | ML entity for inference. | 3GPP TS 32.156 |
| | | [13]) |
| | | multiplicity: * |
| | | isOrdered: False |
| | | isUnique: True |
| | | defaultValue: None |
| | | isNullable: True |
| dataProviderRef | It describes the entities that have provided or | Type: DN (see |
| | should provide data needed by the ML entity | 3GPP TS 32.156 |
| | e.g. for training or inference | [13]) |
| | | multiplicity: * |
| | | isOrdered: False |
| | | isUnique: True |
| | | defaultValue: None |
| | | isNullable: True |
| areNewTrainingDataUsed | It indicates whether the other new training data | type: Boolean |
| | have been used for the ML model training. | multiplicity: 1 |
| | allowedValues: TRUE, FALSE. | isOrdered: N/A |
| | | isUnique: N/A |
| | | defaultValue: None |
| | | isNullable: False |
| trainingDataQualityScore | It indicates numerical value that represents the | Type: Real |
| | dependability/quality of a given observation | multiplicity: 0 . . . 1 |
| | and measurement type. The lowest value | isOrdered: N/A |
| | indicates the lowest level of dependability of | isUnique: N/A |
| | the data, i.e. that the data is not usable at all. | defaultValue: None |
| | allowedValues: {0 . . . 100}. | isNullable: False |
| decisionConfidenceScore | It is the numerical value that represents the | Type: Real |
| | dependability/quality of a given decision | multiplicity: 0 . . . 1 |
| | generated by the AI/ML inference function. | isOrdered: N/A |
| | The lowest value indicates the lowest level of | isUnique: N/A |
| | dependability of the decisions, i.e. that the data | defaultValue: None |
| | is not usable at all. | isNullable: False |
| | allowedValues: {0 . . . 100}. | |
| expectedRuntimeContext | This describes the context where an MLEntity | Type: MLContext |
| | is expected to be applied or/and the | multiplicity: 0 . . . 1 |
| | RunTimeContext which is the context where | isOrdered: N/A |
| | the MLmodel or entity is being applied. | isUnique: N/A |
| | allowedValues: N/A | defaultValue: None |
| | | isNullable: False |
| trainingContext | This specify the context under which the | Type: MLContext |
| | MLEntity has been trained. | multiplicity: 1 |
| | allowedValues: N/A | isOrdered: N/A |
| | | isUnique: N/A |
| | | defaultValue: None |
| | | isNullable: False |
| runTimeContext | This specifies the context where the MLmodel | Type: MLContext |
| | or entity is being applied. | multiplicity: 1 |
| | allowedValues: N/A | isOrdered: N/A |
| | | isUnique: N/A |
| | | defaultValue: None |
| | | isNullable: False |
| mLEntityToTrainRef | It identifies the DN of the MLEntity requested | Type: DN |
| | to be trained. | multiplicity: 1 |
| | allowedValues: DN | isOrdered: False |
| | | isUnique: True |
| | | defaultValue: None |
| | | isNullable: True |
| mLEnityGeneratedRef | It identifies the DN of the MLEntity generated | Type: DN |
| | by the ML training. | multiplicity: 1 |
| | allowedValues: DN | isOrdered: False |
| | | isUnique: True |
| | | defaultValue: None |
| | | isNullable: True |
| mLEntityRepositoryRef | It idenfifies the DN of the | Type: DN |
| | MLEntityRepository. | multiplicity: * |
| | | isOrdered: False |
| | | isUnique: True |
| | | defaultValue: None |
| | | isNullable: False |
| mLRepositoryId | It indicates the unique ID of the ML | type: String |
| | repository. | multiplicity: 1 |
| | | isOrdered: N/A |
| | | isUnique: N/A |
| | | defaultValue: None |
| | | isNullable: False |
| modelPerformanceValidation | It indicates the performance score of the ML | type: |
| | entity when performing on the validation data. | ModelPerformance |
| | allowedValues: N/A. | multiplicity :* |
| | | isOrdered: N/A |
| | | isUnique: N/A |
| | | defaultValue: None |
| | | isNullable: False |
| dataRatioTrainingAndValidation | It indicates the ratio (in terms of quantity of | type: Integer |
| | data samples) of the training data and | multiplicity: 1 |
| | validation data used during the training and | isOrdered: N/A |
| | validation process. It is represented by the | isUnique: N/A |
| | percentage of the validation data samples in | defaultValue: None |
| | the total training data set (including both | isNullable: False |
| | training data samples and validation data | |
| | samples). The value is an integer reflecting the | |
| | rounded number of percent * 100. | |
| | allowedValues: {0 . . . 100}. | |
| mLEntityIdList | It identifies a list of ML entities. | type: String |
| | allowedValues: N/A. | multiplicity: * |
| | | isOrdered: N/A |
| | | isUnique: True |
| | | defaultValue: None |
| | | isNullable: False |
| MLTestingRequest.requestStatus | It describes the status of a particular ML | type: Enum |
| | testing request. | multiplicity: 1 |
| | allowedValues: NOT_STARTED, | isOrdered: N/A |
| | TESTING_IN_PROGRESS, CANCELLING, | isUnique: N/A |
| | SUSPENDED, FINISHED, and | defaultValue: None |
| | CANCELLED. | isNullable: False |
| mLEntityToTestRef | It identifies the DN of the MLEntity requested | Type: DN (see |
| | to be tested. | 3GPP TS 32.156 |
| | allowedValues: DN | [13]) |
| | | multiplicity: 1 |
| | | isOrdered: False |
| | | isUnique: True |
| | | defaultValue: None |
| | | isNullable: True |
| modelPerformanceTesting | It indicates the performance score of the ML | type: |
| | entity when performing on the testing data. | ModelPerformance |
| | allowedValues: N/A. | multiplicity: * |
| | | isOrdered: N/A |
| | | isUnique: N/A |
| | | defaultValue: None |
| | | isNullable: False |
| mlTestingResult | It provides the address where the testing result | type: String |
| | (including the inference result for each testing | multiplicity: 1 |
| | data example) is provided. | isOrdered: False |
| | The detailed testing result format is vendor | isUnique: True |
| | specific. | defaultValue: None |
| | allowedValues: N/A. | isNullable: True |
| testingRequestRef | It identifies the DN of the MLTestingRequest | Type: DN (see |
| | MOI. | 3GPP TS 32.156 |
| | allowedValues: DN | [13]) |
| | | multiplicity: 1 |
| | | isOrdered: False |
| | | isUnique: True |
| | | defaultValue: None |
| | | isNullable: True |
| trainedMLEntityLoadedRef | It identifies the DN of a trained MLEntity | Type: DN (see |
| | whose copy has been loaded to the target | 3GPP TS 32.156 |
| | inference function. The loaded ML entity is | [13]) |
| | represented by another MOI of MLEntity | multiplicity: 1 |
| | contained by the MOI of the target inference | isOrdered: False |
| | function. | isUnique: True |
| | allowedValues: DN | defaultValue: None |
| | | isNullable: True |
| MLEntityLoadingRequest.requestStatus | It describes the status of a particular ML entity | type: Enum |
| | loading request. | multiplicity: 1 |
| | allowedValues: NOT_STARTED, | isOrdered: N/A |
| | LOADING_IN_PROGRESS, | isUnique: N/A |
| | CANCELLING, SUSPENDED, FINISHED, | defaultValue: None |
| | and CANCELLED. | isNullable: False |
| MLEntityLoadingRequest.cancelRequest | It indicates whether the MnS consumer | Type: Boolean |
| | cancels the ML entity loading request. | multiplicity: 0 . . . 1 |
| | Setting this attribute to “TRUE” cancels the | isOrdered: N/A |
| | ML entity training request. Cancellation is | isUnique: N/A |
| | possible when the requestStatus is the | defaultValue: |
| | “NOT_STARTED”, | FALSE |
| | “LOADING_IN_PROGRESS”, and | isNullable: False |
| | “SUSPENDED” state. Setting the attribute to | |
| | “FALSE” has no observable result. | |
| | Default value is set to “FALSE”. | |
| | allowedValues: TRUE, FALSE. | |
| MLEntityLoadingRequest.suspendRequest | It indicates whether the MnS consumer | Type: Boolean |
| | suspends the ML entity loading request. | multiplicity: 0 . . . 1 |
| | Setting this attribute to “TRUE” suspends the | isOrdered: N/A |
| | ML entity loading request. Suspension is | isUnique: N/A |
| | possible when the requestStatus is not the | defaultValue: |
| | “FINISHED” state. Setting the attribute to | FALSE |
| | “FALSE” has no observable result. | isNullable: False |
| | Default value is set to “FALSE”. | |
| | allowedValues: TRUE, FALSE. | |
| mLEntityToLoadRef | It identifies the DN of a trained MLEntity | Type: DN (see |
| | requested to be loaded to the target inference | 3GPP TS 32.156 |
| | function(s). | [13]) |
| | | multiplicity: 1 |
| | | isOrdered: False |
| | | isUnique: True |
| | | defaultValue: None |
| | | isNullable: True |
| targetInferfenceFunctionsRef | It identifies the DN of the MOIs of the target | Type: DN (see |
| | inference function(s) to where the ML entity is | 3GPP TS 32.156 |
| | to be loaded. | [13]) |
| | | multiplicity: * |
| | | isOrdered: False |
| | | isUnique: True |
| | | defaultValue: None |
| | | isNullable: True |
| thresholdMLEntityToLoad | It provides the threshold(s) of the performance | Type: |
| | metric(s) for the trained ML entity to be | ThresholdInfo |
| | loaded. | multiplicity: * |
| | | isOrdered: False |
| | | isUnique: True |
| | | defaultValue: None |
| | | isNullable: True |
| thresholdMLEntityExisting | It provides the threshold(s) of the performance | Type: |
| | metric(s) for the existing ML entity when | ThresholdInfo |
| | conducting inference in the inference function. | multiplicity: * |
| | | isOrdered: False |
| | | isUnique: True |
| | | defaultValue: None |
| | | isNullable: True |
| allowedTimeWindows | It provides the time windows when the ML | Type: |
| | entity loading is allowed. | WeekelyTimeWindow: * |
| | | isOrdered: False |
| | | isUnique: True |
| | | defaultValue: None |
| | | isNullable: True |
| MLEntityLoadingProcess.cancelProcess | It indicates whether the MnS consumer | Type: Boolean |
| | cancels the ML entity loading process. | multiplicity: 0 . . . 1 |
| | Setting this attribute to “TRUE” cancels the | isOrdered: N/A |
| | process. Cancellation is possible when the | isUnique: N/A |
| | “MLEntityLoadingProcess.progressStatus.status” | defaultValue: |
| | is not the “FINISHED” state. Setting the | FALSE |
| | attribute to “FALSE” has no observable result. | isNullable: False |
| | Default value is set to “FALSE”. | |
| | allowedValues: TRUE, FALSE. | |
| MLEntityLoadingProcess.suspendProcess | It indicates whether the MnS consumer | Type: Boolean |
| | suspends the ML entity loading process. | multiplicity: 0 . . . 1 |
| | Setting this attribute to “TRUE” suspends the | isOrdered: N/A |
| | process. Suspension is possible when the | isUnique: N/A |
| | “MLEntityLoadingProcess.progressStatus.status” | defaultValue: |
| | is not the “FINISHED”, “CANCELLING” | FALSE |
| | or “CANCELLED” state. Setting the attribute | isNullable: False |
| | to “FALSE” has no observable result. | |
| | Default value is set to “FALSE”. | |
| | allowedValues: TRUE, FALSE. | |
| MLEntityLoadingRequestRef | It identifies the DN of the associated | Type: DN (see |
| | MLEntityLoadingRequest. | 3GPP TS 32.156 |
| | allowedValues: DN. | [13]) |
| | | multiplicity: 1 |
| | | isOrdered: False |
| | | isUnique: True |
| | | defaultValue: None |
| | | isNullable: True |
| MLEntityLoadingPolicyRef | It identifies the DN of the associated | Type: DN (see |
| | MLEntityLoadingPolicyRef. | 3GPP TS 32.156 |
| | allowedValues: DN. | [13]) |
| | | multiplicity: 1 |
| | | isOrdered: False |
| | | isUnique: True |
| | | defaultValue: None |
| | | isNullable: True |
| performanceMetricName | It identifies the name of the performance | Type: String |
| | metric or measurement. | multiplicity: 1 |
| | AllowedValues: the name of the performance | isOrdered: False |
| | metrics specified for the ML training phase | isUnique: True |
| | and AI/ML inference phase. | defaultValue: None |
| | | isNullable: True |
| thresholdDirection | It indicates the direction of a threshold | Type: ENUM |
| | indicating the direction for which a threshold | multiplicity: 1 |
| | crossing triggers a threshold. | isOrdered: N/A |
| | When the threshold direction is configured to | isUnique: N/A |
| | “UP”, the associated threshold is triggered | defaultValue: None |
| | only when the subject performance metric | isNullable: False |
| | value is equal to or greater than the threshold | |
| | value. The threshold is not triggered, when the | |
| | performance metric value is smaller than the | |
| | threshold value. | |
| | Vice versa, When the threshold direction is | |
| | configured to “DOWN”, the associated | |
| | threshold is triggered only when the subject | |
| | performance metric value is equal or smaller | |
| | than the threshold value. The threshold is not | |
| | triggered, when the performance metric values | |
| | greater than the threshold value. | |
| | allowedValues: | |
| | UP | |
| | DOWN | |
| thresholdValue | It specifies the value against which the | Type: Union |
| | monitored performance metric is compared. | multiplicity: 1 |
| | allowedValues: float or integer | isOrdered: NA |
| | | isUnique: NA |
| | | defaultValue: None |
| | | isNullable: False |
| startTime | It indicates the start time. | Type: String |
| | allowedValues: A valid time format string. | multiplicity: 1 |
| | | isOrdered: N/A |
| | | isUnique: N/A |
| | | defaultValue: None |
| | | isNullable: True |
| stopTime | It indicates the stop time. | Type: String |
| | allowedValues: A valid time format string. | multiplicity: 1 |
| | | isOrdered: N/A |
| | | isUnique: N/A |
| | | defaultValue: None |
| | | isNullable: True |
| dayOfWeek | It indicates the day of the week. | Type: ENUM |
| | allowedValues: | multiplicity: 1 |
| | MONDAY | isOrdered: N/A |
| | TUESDAY | isUnique: N/A |
| | WEDNESDAY | defaultValue: None |
| | THURSDAY | isNullable: True |
| | FRIDAY | |
| | SATURDAY | |
| | SUNDAY | |
| dailyTimeWindows | It provides the time windows for a day. | Type: |
| | allowedValues: N/A | TimeWindow |
| | | multiplicity: * |
| | | isOrdered: N/A |
| | | isUnique: N/A |
| | | defaultValue: None |
| | | isNullable: True |

(NOTE):
When the performanceScore is to indicate the performance score for ML training, the data set is the training data set. When the performanceScore is to indicate the performance score for ML validation, the data set is the validation data set. When the performanceScore is to indicate the performance score for ML testing, the data set is the testing data set.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

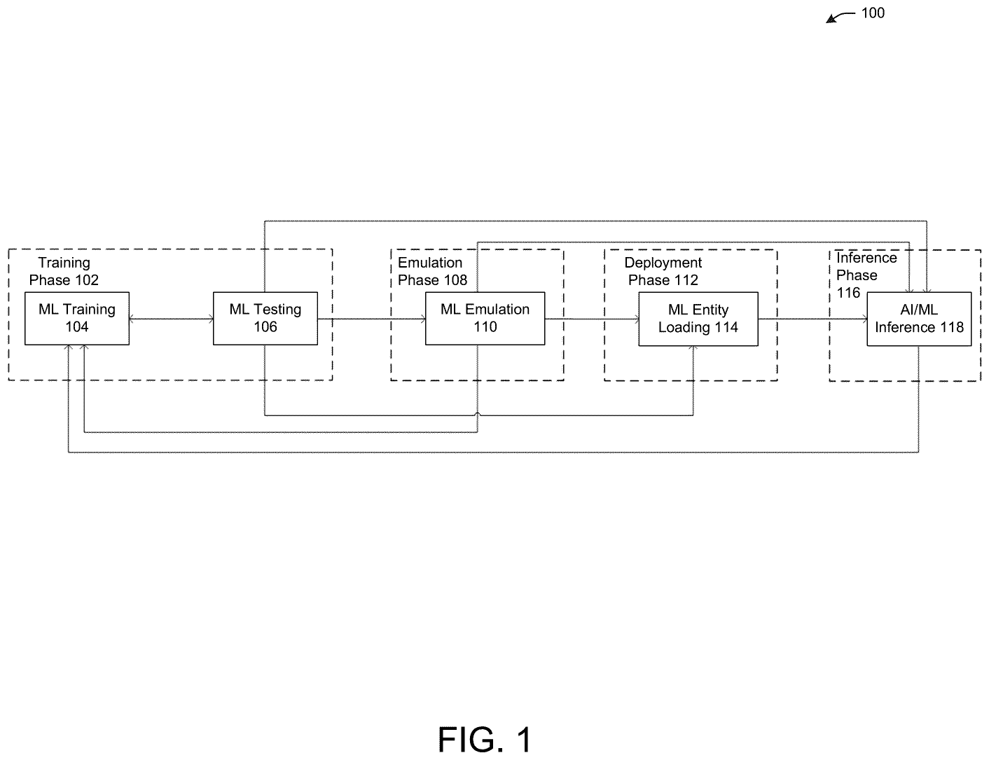

FIG. 1 is an example artificial intelligence/machine learning operational workflow 100, in accordance with one or more example embodiments of the present disclosure.

Referring to FIG. 1, the AI/ML operational workflow 100 may represent a lifecycle of an ML entity in a wireless network. The workflow 100 may include a training phase 102 during which ML training 104 and ML testing 106 are performed, an emulation phase 108 during which ML emulation 110 is performed, a deployment phase 112 during which ML entity loading 114 occurs, and an inference phase 116 during which AI/ML inferencing 118 occurs.

The training phase 102 includes ML training 104 (MLT) and ML testing 106 (or ML model testing). In some implementations, some or all of the MLT 104 and/or ML testing 106 operational tasks may be performed by an MLT MnS-P, although in other implementations at least some of the MLT 104 and/or ML testing 106 operational tasks are performed by an MLT MnS-C. In the training phase 102, the ML entity is generated based on learning from training data, while performance and trustworthiness are evaluated on validation data

ML testing 106 involves the testing of the validated ML entity to evaluate the performance of the trained ML entity when it performs on testing data. If the testing result meets the expectation, the ML entity may proceed to the next phase, otherwise the ML entity may need to be re-trained. Additionally or alternatively, the ML testing 106 (or model testing) involves performing one or more processes to validate ML model performance using testing data (or testing data set). When the performance of the trained ML entity meets the expectations on both training data and validation data, the ML entity is finally tested to evaluate the performance on testing data. If the testing result meets the expectation, the ML entity may be counted as a candidate for use towards the intended use case or task, otherwise the ML entity may need to be further (re)trained.

In some cases, the ML entity may need to be verified, which is a special case of testing to check whether the ML entity (or ML model) works when deployed in or at the target node (e.g., an AI/ML inference function, inference engine, intelligent agent, and/or the like). In some implementations, the ML entity (or ML model) verification involves verifying ML entity (or ML model) performance when deployed and/or online in the intended or desired environment. In some examples, the verification includes or involves inference monitoring, wherein ML inferences/predictions are collected and anal6ed (e.g., by collecting ModelPerformance data as discussed in [TS28105]). In these implementations, the verification results may be part of the ML entity (or ML model) validation results, or may be reported in a same or similar manner as the validation results as discussed herein. In some implementations, the verification process may be skipped, for example, in case the input and output data, data types, and/or formats have been unchanged from the last ML entity.

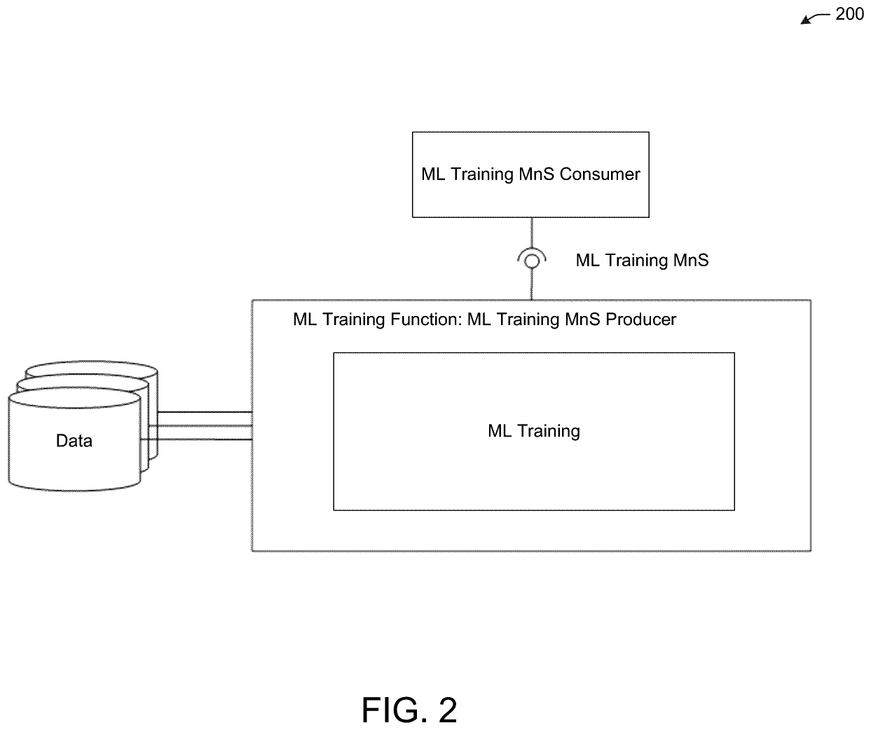

FIG. 2 is an example functional overview and service framework 200 for machine learning training, in accordance with one or more example embodiments of the present disclosure.

An MLT function playing the role of MLT MnS-P may consume various data for MLT purposes. FIG. 2 shows an example of the MLT capability is provided via MLT MnS in the context of SBMA to the authorized consumer(s) by MLT MnS-P.

The operational steps in the AI/ML workflow (e.g., as depicted by FIGS. 1 and 2) is supported by the specific AI/ML management capabilities as discussed below.

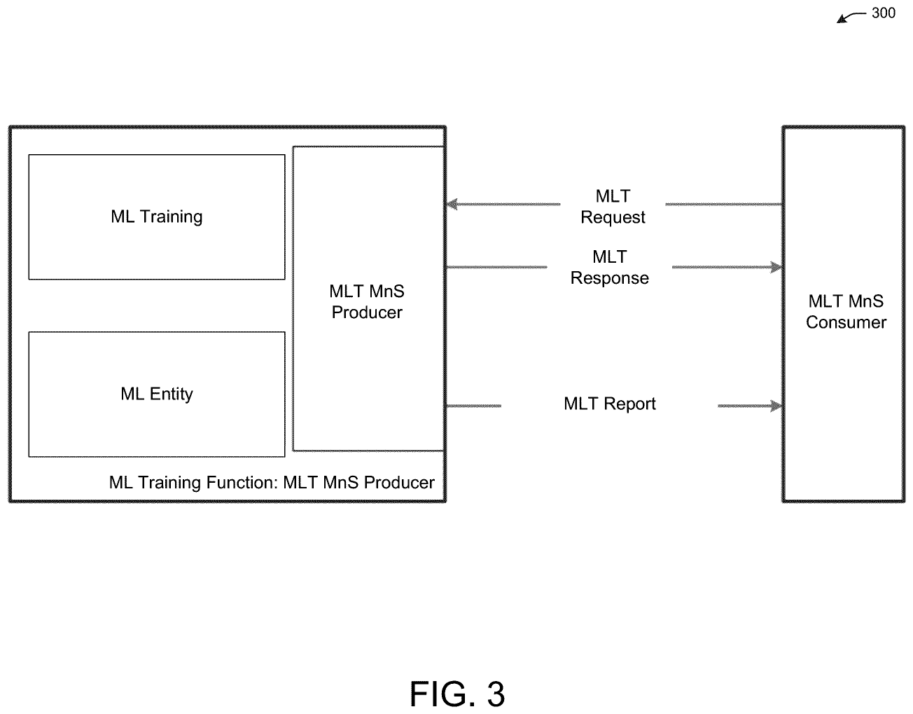

FIG. 3 illustrates example machine learning training 300 requested by an MnS consumer, in accordance with one or more example embodiments of the present disclosure.

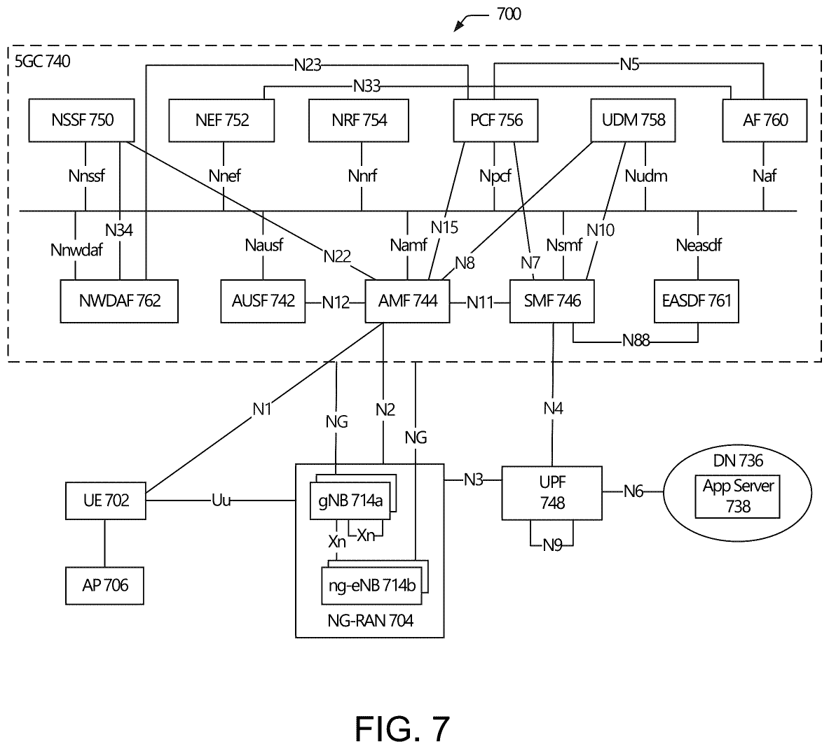

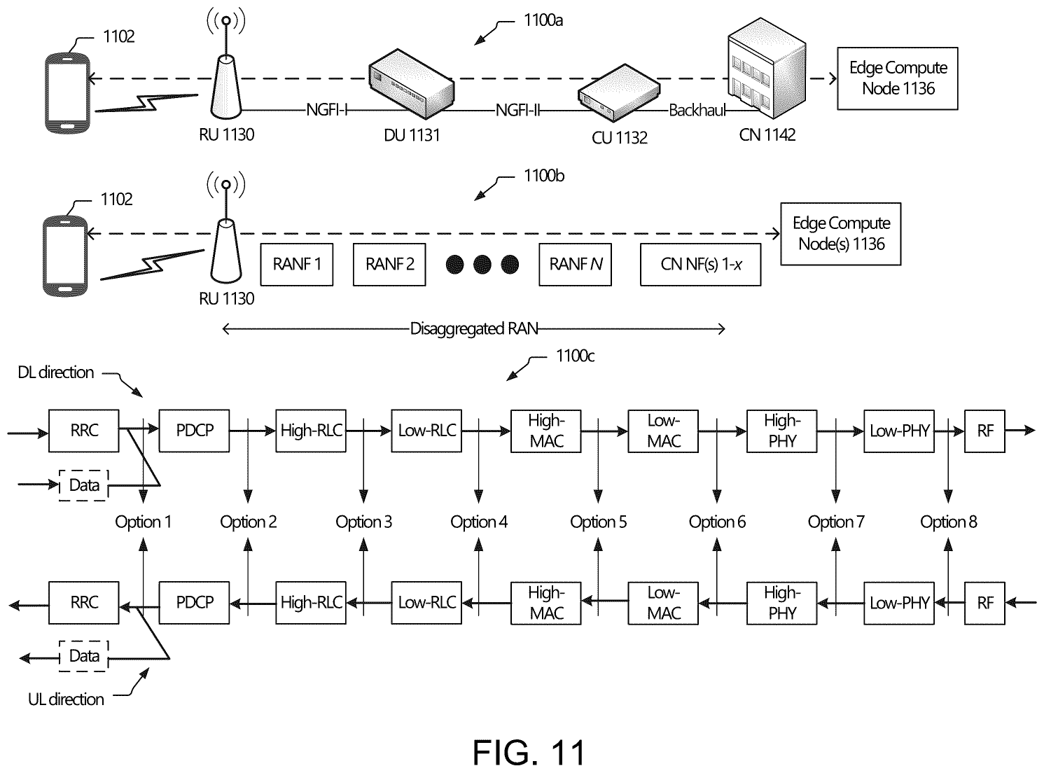

FIG. 3 depicts an example of MLT requested by an MLT MnS consumer (MnS-C). Here, an MLT MnS producer (MnS-P) acts as an MLT function (MLT function). MLT capabilities are provided by the MLT MnS-P to one or more MLT consumer(s) (e.g., MLT MnS consumer(s) in FIG. 3). As examples, the consumer(s) can include one or more network functions (NFs) (e.g., an NWDAF containing analytics logical function (AnLF)), management functions (MFs), RAN functions (RANFs) (see e.g., FIG. 11), edge compute nodes (or edge compute functions), application functions (AFs) (e.g., AF 760 in FIG. 7), an operator (or operator roles), and/or another functional differentiation.

The MLT may be triggered by the request(s) (e.g., the MLT training request in FIG. 2) from one or more MLT MnS-C(s). The consumer may be for example a network function, a management function, an operator, or another functional differentiation.

To trigger an initial ML entity training, the MnS-C needs to specify in the MLT request the inference type which indicates the function or purpose of the ML entity (e.g., CoverageProblemAnalysis, NES, MRO, LBO, and/or the like). The MLT MnS-P can perform the initial training according to the designated inference type. To trigger an ML entity re-training, the MnS-C needs to specify in the MLT request the identifier of the ML entity to be re-trained.

Each ML entity supports a specific type of inference. An AI/ML inference function may use one or more ML entities to perform the inference(s). When multiple ML entities are employed, these ML entities may operate together in a coordinated way, such as in a sequence, or even a more complicated structure. In this case, any change in the performance of one ML entity may impact another, and consequently impact the overall performance of the whole AI/ML inference function.

There are different ways in which the group of ML entities may coordinate. An example is the case where the output of one ML entity can be used as input to another ML entity forming a sequence of interlinked ML entities. Another example is the case where multiple ML entities provide the output in parallel (either the same output type where outputs may be merged (e.g., using weights), or their outputs are needed in parallel as input to another ML entity. The group of ML entities needs to be employed in a coordinated way to support an AI/ML inference function.

Therefore, it is desirable that these coordinated ML entities can be trained or re-trained jointly, so that the group of these ML entities can complete a more complex task jointly with better performance.

The ML entity joint training may be initiated by the MnS-P or the MnS-C, with the grouping of the ML entities shared by the MnS-P with the MnS-C.

During the MLT process, the generated ML entity needs to be validated. The purpose of ML validation is to evaluate the performance of the trained ML entity when performing on the validation data, and to identify the variance of the performance on the training data and the validation data. The training data and validation data are of the same pattern as they normally split from the same data set with a certain ratio in terms of the quantity of the data samples.

In the MLT, the ML entity is generated based on the learning from the training data, and validated using validation data. The performance of the ML entity has tight dependency on the data (i.e., training data) from which the ML entity is generated. Therefore, an ML entity performing well on the training data may not necessarily perform well on other data e.g., while conducting inference. If the performance of ML entity is not good enough according to the result of ML validation, the ML entity will be tuned (re-trained) and validated again. The process of ML entity tuning and validation is repeated by the MLT function, until the performance of the ML entity meets the expectation on both training data and validation data. The MnS-P subsequently selects one or more ML entities with the best level of performance on both training data and validation data as the result of the MLT, and reports accordingly to the consumer. The performance of each selected ML entity on both training data and validation data also needs to be reported.

After receiving an MLT report about a trained ML entity from the MLT MnS-P, the consumer may request the ML testing MnS-P to test the ML entity before applying it to the target inference function. The ML testing is to conduct inference on the tested ML entity using the testing data as the inference inputs and produce the inference output for each testing dataset example. The ML testing MnS-P may be the same as or different from the MLT MnS-P.

After completing the ML testing, the ML testing MnS-P provides the testing report indicating the success or failure of the ML testing to the consumer. For a successful ML testing, the testing report contains the testing results, for example, the inference output for each testing dataset example.

The ML entity testing may also be initiated by the MnS-P, after the ML entity is trained and validated. A consumer (e.g., an operator) may still need to define the policies (e.g., allowed time window, maximum number of testing iterations, etc.) for the testing of a given ML entity. The consumer may pre-define performance requirements for the ML entity testing and allow the MnS-P to decide on whether re-training/validation need to be triggered. Re-training may be triggered by the testing MnS-P itself based on the performance requirements supplied by the MnS-C.

If the testing performance is not acceptable or does not meet pre-defined or configured requirements, the consumer may request the MLT producer to re-train the ML entity with specific training data and/or performance requirements.

A group of ML entities may work in a coordinated manner for complex use cases. In such cases, an ML entity is just one step of the inference processes of an AI/ML inference function, with the inference outputs of an ML entity as the inputs to the next ML entity. The group of ML entities is generated by the MLT function. The group, including all contained ML entities, needs to be tested.

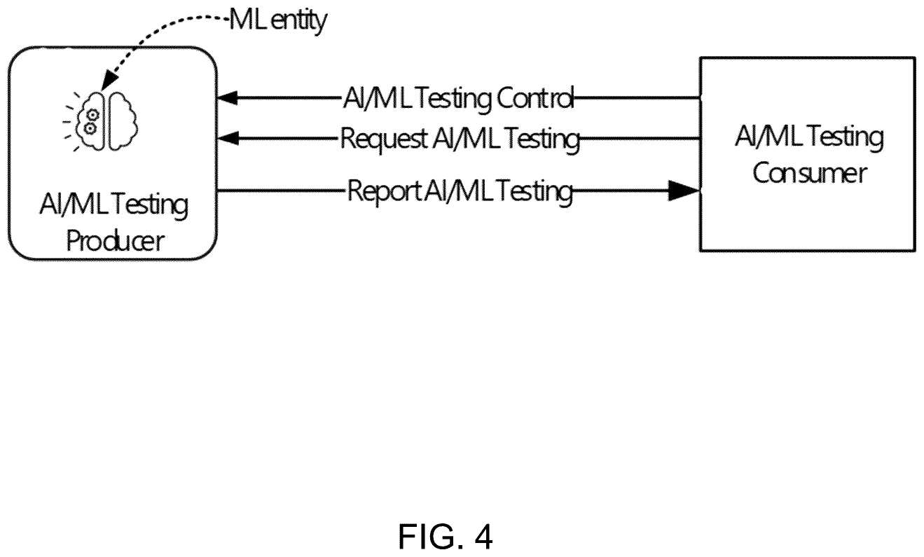

FIG. 4 shows an example testing request and reporting procedure 400, in accordance with one or more embodiments of the present disclosure.

Referring to FIG. 4, the ML testing may be requested by an MnS-C (e.g., the AI/ML testing consumer in FIG. 4), or initiated by the MnS-P (e.g., the AI/ML testing producer in FIG. 4). After the ML testing of the group, the MnS-P provides the testing results to the consumer.

In some examples, the use case is about the ML entities testing during the training phase and irrelevant to the testing cases that the ML entities have been deployed. In some examples, the ML testing MnS-P has a capability allowing an authorized consumer to request the testing of a group of ML entities.

The present disclosure provides solutions for joint testing of multiple ML entities. In various embodiments, the joint testing of multiple ML entities involves using Information Object Classes (IOCs) that are managed through the operations and notifications of generic provisioning management service defined in [TS28532]. In these ways, the aspects discussed herein allows ML to bring intelligence and automation to 5GS 700.

The following discussion provides various examples names/labels for various parameters, attributes, information elements (IEs), information object classes (IOCs), managed object classes (MOCs), and other elements/data structures; however, the specific names used regarding the various parameters, attributes, IEs, IOCs, MOCs, and/or the like, are provided for the purpose of discussion and illustration, rather than limitation. It should be noted that the various parameters, attributes, IEs, IOCs, MOCs, etc., can have alternative names to those provided infra, and in additional or alternative embodiments, implementations, and/or iterations of the 3GPP specifications, the names may be different but still fall within the context of the present description.

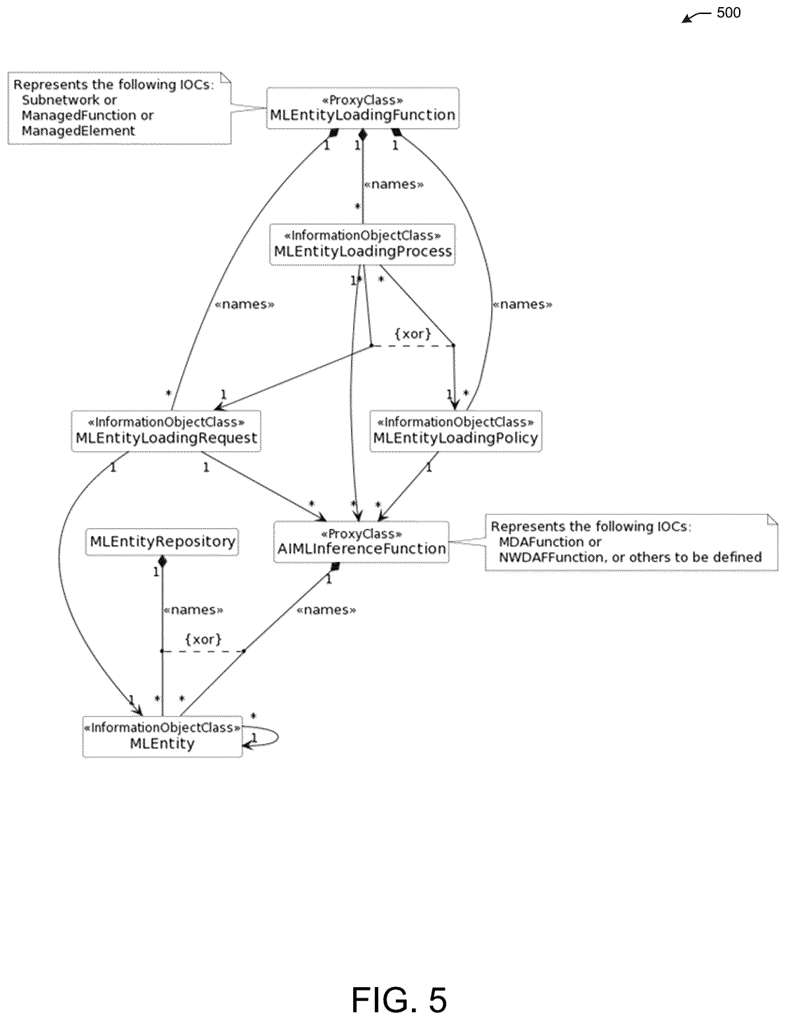

FIG. 5 shows example a network resource model fragment 500 for machine learning entity loading, in accordance with one or more embodiments of the present disclosure.

The set of classes (e.g., IOCs) that encapsulate the information relevant to the ML deployment phase are provided, and 3GPP TS 32.156 provides UML semantics.

FIG. 5 shows the relationships between the MLEntityLoadingFunction <<ProxyClass>> representing the Subnetwork, ManagedFunction, or ManagedElement IOCs, the MLEntityLoadingProcess <<InformationObjectClass>>, the MLEntityLoadingRequest <<InformationObjectClass>>, the MLEntityLoadingPolicy <<InformationObjectClass>>, the MLEntityRepository, the AIMLInference Function <<ProxyClass>> representing the MDAFuntion or NWDAFFunction, and the MLEntity <<InformationObjectClass>>.

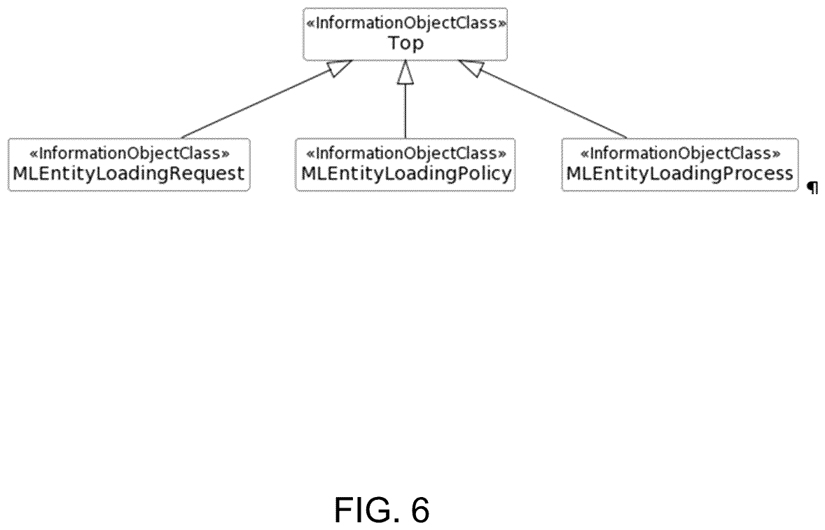

FIG. 6 shows an example inheritance hierarchy 600 for machine learning entity loading related network resource models, in accordance with one or more embodiments of the present disclosure.

Referring to FIG. 6, the MLEntityLoadingRequest <<InformationObjectClass>>, the MLEntityLoadingPolicy <<InformationObjectClass>>, and the MLEntityLoadingProcess <<InformationObjectClass>> inherit from the Top <<InformationObjectClass>>.

FIG. 7 depicts an example network architecture 700. The network 700 may operate in a manner consistent with 3GPP technical specifications for LTE or 5G/NR systems. However, the example embodiments are not limited in this regard and the described examples may apply to other networks that benefit from the principles described herein, such as future 3GPP systems, or the like.

The network 700 includes a UE 702, which is any mobile or non-mobile computing device designed to communicate with a RAN 704 via an over-the-air connection. The UE 702 is communicatively coupled with the RAN 704 by a Uu interface, which may be applicable to both LTE and NR systems. Examples of the UE 702 include, but are not limited to, a smartphone, tablet computer, wearable device (e.g., smart watch, fitness tracker, smart glasses, smart clothing/fabrics, head-mounted displays, smart shows, and/or the like), desktop computer, workstation, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, smart appliance, flying drone or unmanned aerial vehicle (UAV), terrestrial drone or autonomous vehicle, robot, electronic signage, single-board computer (SBC) (e.g., Raspberry Pi, Arduino, Intel Edison, and the like), plug computers, and/or any type of computing device such as any of those discussed herein.

The network 700 may include a set of UEs 702 coupled directly with one another via a D2D, ProSe, PC5, and/or sidelink (SL) interface, and/or any other suitable interface such as any of those discussed herein. In 3GPP systems, SL communication involves communication between two or more UEs 702 using 3GPP technology without traversing a network node. These UEs 702 may be M2M/D2D/MTC/IoT devices and/or vehicular systems that communicate using an SL interface, which includes, for example, one or more SL logical channels (e.g., Sidelink Broadcast Control Channel (SBCCH), Sidelink Control Channel (SCCH), and Sidelink Traffic Channel (STCH)); one or more SL transport channels (e.g., Sidelink Shared Channel (SL-SCH) and Sidelink Broadcast Channel (SL-BCH)); and one or more SL physical channels (e.g., Physical Sidelink Shared Channel (PSSCH), Physical Sidelink Control Channel (PSCCH), Physical Sidelink Feedback Channel (PSFCH), Physical Sidelink Broadcast Channel (PSBCH), and/or the like). The UE 702 may perform blind decoding attempts of SL channels/links according to the various examples herein.

In some examples, the UE 702 may additionally communicate with an AP 706 via an over-the-air (OTA) connection. The AP 706 manages a WLAN connection, which may serve to offload some/all network traffic from the RAN 704. The connection between the UE 702 and the AP 706 may be consistent with any IEEE 802.11 protocol. Additionally, the UE 702, RAN 704, and AP 706 may utilize cellular-WLAN aggregation/integration (e.g., LWA/LWIP). Cellular-WLAN aggregation may involve the UE 702 being configured by the RAN 704 to utilize both cellular radio resources and WLAN resources.

The RAN 704 includes one or more access network nodes (ANs) 708. The ANs 708 terminate air-interface(s) for the UE 702 by providing access stratum protocols including RRC, PDCP, RLC, MAC, and PHY/L1 protocols. In this manner, the AN 708 enables data/voice connectivity between CN 720 and the UE 702. The ANs 708 may be a macrocell base station or a low power base station for providing femtocells, picocells or other like cells having smaller coverage areas, smaller user capacity, or higher bandwidth compared to macrocells; or some combination thereof. In these implementations, an AN 708 be referred to as a BS, gNB, RAN node, eNB, ng-eNB, NodeB, RSU, TRxP, and the like.

One example implementation is a “CU/DU split” architecture where the ANs 708 are embodied as a gNB-Central Unit (CU) that is communicatively coupled with one or more gNB-Distributed Units (DUs), where each DU may be communicatively coupled with one or more Radio Units (RUs) (also referred to as RRHs, RRUs, or the like). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The ANs 708 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architectures, arrangements, and/or configurations can be used.

The set of ANs 708 are coupled with one another via respective X2 interfaces if the RAN 704 is an LTE RAN or Evolved Universal Terrestrial Radio Access Network (E-UTRAN) 710, or respective Xn interfaces if the RAN 704 is a NG-RAN 714. The X2/Xn interfaces, which may be separated into control/user plane interfaces in some examples, may allow the ANs to communicate information related to handovers, data/context transfers, mobility, load management, interference coordination, and the like.

The ANs of the RAN 704 may each manage one or more cells, cell groups, component carriers, and the like to provide the UE 702 with an air interface for network access. The UE 702 may be simultaneously connected with a set of cells provided by the same or different ANs 708 of the RAN 704. For example, the UE 702 and RAN 704 may use carrier aggregation to allow the UE 702 to connect with a set of component carriers, each corresponding to a Pcell or Scell. In dual connectivity scenarios, a first AN 708 may be a master node that provides an MCG and a second AN 708 may be secondary node that provides an SCG. The first/second ANs 708 may be any combination of eNB, gNB, ng-eNB, and the like.

The RAN 704 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

Additionally or alternatively, individual UEs 702 provide radio information to one or more ANs 708 and/or one or more edge compute nodes (e.g., edge servers/hosts, and the like). The radio information may be in the form of one or more measurement reports, and/or may include, for example, signal strength measurements, signal quality measurements, and/or the like. Each measurement report is tagged with a timestamp and the location of the measurement (e.g., the UEs 702 current location).

The UE 702 can also perform determine reference signal (RS) measurement and reporting procedures to provide the network with information about the quality of one or more wireless channels and/or the communication media in general, and this information can be used to optimize various aspects of the communication system.

In V2X scenarios the UE 702 or AN 708 may be or act as a roadside unit (RSU), which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network. Furthermore, one or more V2X RATs may be employed, which allow V2X nodes to communicate directly with one another, with infrastructure equipment (e.g., AN 708), and/or other devices/nodes. In some implementations, at least two distinct V2X RATs may be used including WLAN V2X (W-V2X) RATs based on IEEE V2X technologies (e.g., DSRC for the U.S. and ITS-G5 for Europe) and cellular V2X (C-V2X) RATs based on 3GPP V2X technologies (e.g., LTE V2X, 5G/NR V2X, and beyond). In one example, the C-V2X RAT may utilize a C-V2X air interface and the WLAN V2X RAT may utilize an W-V2X air interface.

In examples where the RAN 704 is an E-UTRAN 710 with one or more eNBs 712, the E-UTRAN 710 provides an LTE air interface (Uu) with the parameters and characteristics at least as discussed in 3GPP TS 36.300 v17.2.0 (2022 Sep. 30) (“[TS36300]”). In examples where the RAN 704 is an next generation (NG)-RAN 714 with a set of gNBs 716. Each gNB 716 connects with 5G-enabled UEs 702 using a 5G-NR air interface (which may also be referred to as a Uu interface) with parameters and characteristics as discussed in [TS38300], among many other 3GPP standards. Where the NG-RAN 714 includes a set of ng-eNBs 718, the one or more ng-eNBs 718 connect with a UE 702 via the 5G Uu and/or LTE Uu interface. The gNBs 716 and the ng-eNBs 718 connect with the 5GC 740 through respective NG interfaces, which include an N2 interface, an N3 interface, and/or other interfaces. The gNB 716 and the ng-eNB 718 are connected with each other over an Xn interface. Additionally, individual gNBs 716 are connected to one another via respective Xn interfaces, and individual ng-eNBs 718 are connected to one another via respective Xn interfaces. In some examples, the NG interface may be split into two parts, an NG user plane (NG-U) interface, which carries traffic data between the nodes of the NG-RAN 714 and a UPF 748 (e.g., N3 interface), and an NG control plane (NG-C) interface, which is a signaling interface between the nodes of the NG-RAN 714 and an AMF 744 (e.g., N2 interface).

The NG-RAN 714 may provide a 5G-NR air interface (which may also be referred to as a Uu interface) with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

The 5G-NR air interface may utilize BWPs for various purposes. For example, BWP can be used for dynamic adaptation of the SCS. For example, the UE 702 can be configured with multiple BWPs where each BWP configuration has a different SCS. When a BWP change is indicated to the UE 702, the SCS of the transmission is changed as well. Another use case example of BWP is related to power saving. In particular, multiple BWPs can be configured for the UE 702 with different amount of frequency resources (e.g., PRBs) to support data transmission under different traffic loading scenarios. A BWP containing a smaller number of PRBs can be used for data transmission with small traffic load while allowing power saving at the UE 702 and in some cases at the gNB 716. A BWP containing a larger number of PRBs can be used for scenarios with higher traffic load.

In some implementations, individual gNBs 716 can include a gNB-CU and a set of gNB-DUs. Additionally or alternatively, gNBs 716 can include one or more RUs. In these implementations, the gNB-CU may be connected to each gNB-DU via respective F1 interfaces. In case of network sharing with multiple cell ID broadcast(s), each cell identity associated with a subset of PLMNs corresponds to a gNB-DU and the gNB-CU it is connected to, share the same physical layer cell resources. For resiliency, a gNB-DU may be connected to multiple gNB-CUs by appropriate implementation. Additionally, a gNB-CU can be separated into gNB-CU control plane (gNB-CU-CP) and gNB-CU user plane (gNB-CU-UP) functions. The gNB-CU-CP is connected to a gNB-DU through an F1 control plane interface (F1-C), the gNB-CU-UP is connected to the gNB-DU through an F1 user plane interface (F1-U), and the gNB-CU-UP is connected to the gNB-CU-CP through an E1 interface. In some implementations, one gNB-DU is connected to only one gNB-CU-CP, and one gNB-CU-UP is connected to only one gNB-CU-CP. For resiliency, a gNB-DU and/or a gNB-CU-UP may be connected to multiple gNB-CU-CPs by appropriate implementation. One gNB-DU can be connected to multiple gNB-CU-UPs under the control of the same gNB-CU-CP, and one gNB-CU-UP can be connected to multiple DUs under the control of the same gNB-CU-CP. Data forwarding between gNB-CU-UPs during intra-gNB-CU-CP handover within a gNB may be supported by Xn-U.

Similarly, individual ng-eNBs 718 can include an ng-eNB-CU and a set of ng-eNB-DUs. In these implementations, the ng-eNB-CU and each ng-eNB-DU are connected to one another via respective W1 interface. An ng-eNB can include an ng-eNB-CU-CP, one or more ng-eNB-CU-UP(s), and one or more ng-eNB-DU(s). An ng-eNB-CU-CP and an ng-eNB-CU-UP is connected via the E1 interface. An ng-eNB-DU is connected to an ng-eNB-CU-CP via the W1-C interface, and to an ng-eNB-CU-UP via the W1-U interface. The general principle described herein w.r.t gNB aspects also applies to ng-eNB aspects and corresponding E1 and W1 interfaces, if not explicitly specified otherwise.

The node hosting user plane part of the PDCP protocol layer (e.g., gNB-CU, gNB-CU-UP, and for EN-DC, MeNB or SgNB depending on the bearer split) performs user inactivity monitoring and further informs its inactivity or (re)activation to the node having control plane connection towards the core network (e.g., over E1, X2, or the like). The node hosting the RLC protocol layer (e.g., gNB-DU) may perform user inactivity monitoring and further inform its inactivity or (re)activation to the node hosting the control plane (e.g., gNB-CU or gNB-CU-CP).

In these implementations, the NG-RAN 714, is layered into a Radio Network Layer (RNL) and a Transport Network Layer (TNL). The NG-RAN 714 architecture (e.g., the NG-RAN logical nodes and interfaces between them) is part of the RNL. For each NG-RAN interface (e.g., NG, Xn, F1, and the like) the related TNL protocol and the functionality are specified. The TNL provides services for user plane transport and/or signalling transport. In NG-Flex configurations, each NG-RAN node is connected to all AMFs 744 of AMF sets within an AMF region supporting at least one slice also supported by the NG-RAN node. The AMF Set and the AMF Region are defined in [TS23501].

The RAN 704 is communicatively coupled to CN 720 that includes network elements and/or network functions (NFs) to provide various functions to support data and telecommunications services to customers/subscribers (e.g., UE 702). The components of the CN 720 may be implemented in one physical node or separate physical nodes. In some examples, NFV may be utilized to virtualize any or all of the functions provided by the network elements of the CN 720 onto physical compute/storage resources in servers, switches, and the like. A logical instantiation of the CN 720 may be referred to as a network slice, and a logical instantiation of a portion of the CN 720 may be referred to as a network sub-slice.

In the example of FIG. 7, the CN 740 is a 5GC 740 including an Authentication Server Function (AUSF) 742, Access and Mobility Management Function (AMF) 744, Session Management Function (SMF) 746, User Plane Function (UPF) 748, Network Slice Selection Function (NSSF) 750, Network Exposure Function (NEF) 752, Network Repository Function (NRF) 754, Policy Control Function (PCF) 756, Unified Data Management (UDM) 758, Unified Data Repository (UDR), Application Function (AF) 760, and Network Data Analytics Function (NWDAF) 762 coupled with one another over various interfaces as shown. The NFs in the 5GC 740 are briefly introduced as follows.

The NWDAF 762 includes one or more of the following functionalities: support data collection from NFs and AFs 760; support data collection from OAM; NWDAF service registration and metadata exposure to NFs and AFs 760; support analytics information provisioning to NFs and AFs 760; support machine learning (ML) model training and provisioning to NWDAF(s) 762 (e.g., those containing analytics logical function). Some or all of the NWDAF functionalities can be supported in a single instance of an NWDAF 762. The NWDAF 762 also includes an analytics reporting capability, which comprises means that allow discovery of the type of analytics that can be consumed by an external party and/or the request for consumption of analytics information generated by the NWDAF 762.

The NWDAF 762 interacts with different entities for different purposes, such as one or more of the following: data collection based on subscription to events provided by AMF 744, SMF 746, PCF 756, UDM 758, NSACF, AF 760 (directly or via NEF 752) and OAM (not shown); analytics and data collection using the Data Collection Coordination Function (DCCF); retrieval of information from data repositories (e.g. UDR via UDM 758 for subscriber-related information); data collection of location information from LCS system; storage and retrieval of information from an Analytics Data Repository Function (ADRF); analytics and data collection from a Messaging Framework Adaptor Function (MFAF); retrieval of information about NFs (e.g. from NRF 754 for NF-related information); on-demand provision of analytics to consumers, as specified in clause 6 of [TS23288]; and/or provision of bulked data related to analytics ID(s). NWDAF discovery and selection procedures are discussed in clause 6.3.13 in [TS23501] and clause 5.2 of [TS23288].

A single instance or multiple instances of NWDAF 762 may be deployed in a PLMN. If multiple NWDAF 762 instances are deployed, the architecture supports deploying the NWDAF 762 as a central NF, as a collection of distributed NFs, or as a combination of both. If multiple NWDAF 762 instances are deployed, an NWDAF 762 can act as an aggregate point (e.g., aggregator NWDAF 762) and collect analytics information from other NWDAFs 762, which may have different serving areas, to produce the aggregated analytics (e.g., per analytics ID), possibly with analytics generated by itself. When multiple NWDAFs 762 exist, not all of them need to be able to provide the same type of analytics results. For example, some of the NWDAFs 762 can be specialized in providing certain types of analytics. An analytics ID information element is used to identify the type of supported analytics that NWDAF 762 can generate. In some implementations, NWDAF 762 instance(s) can be collocated with a 5GS NF. Additional aspects of NWDAF 762 functionality are defined in 3GPP TS 23.288 v18.2.0 (2023 Jun. 21) (“[TS23288]”).

Different NWDAF 762 instances may be present in the 5GC 740, with possible specializations per type of analytics. The capabilities of an NWDAF 762 instance are described in the NWDAF profile stored in the NRF 754. The NWDAF architecture allows for arranging multiple NWDAF 762 instances in a hierarchy/tree with a flexible number of layers/branches. The number and organisation of the hierarchy layers, as well as the capabilities of each NWDAF 762 instance remain deployment choices and may vary depending on implementation and/or use case. In a hierarchical deployment, NWDAFs 762 may provide data collection exposure capability for generating analytics based on the data collected by other NWDAFs 762, when DCCFs 763 and/or MFAFs 765 are not present in the network.

The AUSF 742 stores data for authentication of UE 702 and handle authentication-related functionality. The AUSF 742 may facilitate a common authentication framework for various access types.

The AMF 744 allows other functions of the 5GC 740 to communicate with the UE 702 and the RAN 704 and to subscribe to notifications about mobility events w.r.t the UE 702. The AMF 744 is also responsible for registration management (e.g., for registering UE 702), connection management, reachability management, mobility management, lawful interception of AMF-related events, and access authentication and authorization. The AMF 744 provides transport for SM messages between the UE 702 and the SMF 746, and acts as a transparent proxy for routing SM messages. AMF 744 also provides transport for SMS messages between UE 702 and an SMSF. AMF 744 interacts with the AUSF 742 and the UE 702 to perform various security anchor and context management functions. Furthermore, AMF 744 is a termination point of a RAN-CP interface, which includes the N2 reference point between the RAN 704 and the AMF 744. The AMF 744 is also a termination point of NAS (N1) signaling, and performs NAS ciphering and integrity protection.

The AMF 744 also supports NAS signaling with the UE 702 over an N3IWF interface. The N3IWF provides access to untrusted entities. N3IWF may be a termination point for the N2 interface between the (R)AN 704 and the AMF 744 for the control plane, and may be a termination point for the N3 reference point between the (R)AN 704 and the 748 for the user plane. As such, the AMF 744 handles N2 signaling from the SMF 746 and the AMF 744 for PDU sessions and QoS, encapsulate/de-encapsulate packets for IPSec and N3 tunneling, marks N3 user-plane packets in the UL, and enforces QoS corresponding to N3 packet marking taking into account QoS requirements associated with such marking received over N2. N3IWF may also relay UL and DL control-plane NAS signaling between the UE 702 and AMF 744 via an N1 reference point between the UE 702 and the AMF 744, and relay UL and DL user-plane packets between the UE 702 and UPF 748. The N3IWF also provides mechanisms for IPsec tunnel establishment with the UE 702. The AMF 744 may exhibit an Namf service-based interface, and may be a termination point for an N14 reference point between two AMFs 744 and an N17 reference point between the AMF 744 and a 5G-EIR (not shown by FIG. 7). In addition to the functionality of the AMF 744 described herein, the AMF 744 may provide support for Network Slice restriction and Network Slice instance restriction based on NWDAF analytics.

The SMF 746 is responsible for SM (e.g., session establishment, tunnel management between UPF 748 and AN 708); UE IP address allocation and management (including optional authorization); selection and control of UP function; configuring traffic steering at UPF 748 to route traffic to proper destination; termination of interfaces toward policy control functions; controlling part of policy enforcement, charging, and QoS; lawful intercept (for SM events and interface to LI system); termination of SM parts of NAS messages; DL data notification; initiating AN specific SM information, sent via AMF 744 over N2 to AN 708; and determining SSC mode of a session. SM refers to management of a PDU session, and a PDU session or “session” refers to a PDU connectivity service that provides or enables the exchange of PDUs between the UE 702 and the DN 736. The SMF 746 may also include the following functionalities to support edge computing enhancements (see e.g., [TS23548]): selection of EASDF 761 and provision of its address to the UE as the DNS server for the PDU session; usage of EASDF 761 services as defined in [TS23548]; and for supporting the application layer architecture defined in [TS23558], provision and updates of ECS address configuration information to the UE. Discovery and selection procedures for EASDFs 761 is discussed in [TS23501] § 6.3.23.

The UPF 748 acts as an anchor point for intra-RAT and inter-RAT mobility, an external PDU session point of interconnect to data network 736, and a branching point to support multi-homed PDU session. The UPF 748 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs UL traffic verification (e.g., SDF-to-QoS flow mapping), transport level packet marking in the UL and DL, and performs DL packet buffering and DL data notification triggering. UPF 748 may include an UL classifier to support routing traffic flows to a data network.

The NSSF 750 selects a set of network slice instances serving the UE 702. The NSSF 750 also determines allowed NSSAI and the mapping to the subscribed S-NSSAIs, if needed. The NSSF 750 also determines an AMF set to be used to serve the UE 702, or a list of candidate AMFs 744 based on a suitable configuration and possibly by querying the NRF 754. The selection of a set of network slice instances for the UE 702 may be triggered by the AMF 744 with which the UE 702 is registered by interacting with the NSSF 750; this may lead to a change of AMF 744. The NSSF 750 interacts with the AMF 744 via an N22 reference point; and may communicate with another NSSF in a visited network via an N31 reference point (not shown).

The NEF 752 securely exposes services and capabilities provided by 3GPP NFs for third party, internal exposure/re-exposure, AFs 760, edge computing networks/frameworks, and the like. In such examples, the NEF 752 may authenticate, authorize, or throttle the AFs 760. The NEF 752 stores/retrieves information as structured data using the Nudr interface to a Unified Data Repository (UDR). The NEF 752 also translates information exchanged with the AF 760 and information exchanged with internal NFs. For example, the NEF 752 may translate between an AF-Service-Identifier and an internal 5GC information, such as DNN, S-NSSAI, as described in clause 5.6.7 of [TS23501]. In particular, the NEF 752 handles masking of network and user sensitive information to external AF's 760 according to the network policy. The NEF 752 also receives information from other NFs based on exposed capabilities of other NFs. This information may be stored at the NEF 752 as structured data, or at a data storage NF using standardized interfaces. The stored information can then be re-exposed by the NEF 752 to other NFs and AFs, or used for other purposes such as analytics. For example, NWDAF analytics may be securely exposed by the NEF 752 for external party, as specified in [TS23288]. Furthermore, data provided by an external party may be collected by the NWDAF 762 via the NEF 752 for analytics generation purpose. The NEF 752 handles and forwards requests and notifications between the NWDAF 762 and AF(s) 760, as specified in [TS23288].

The NRF 754 supports service discovery functions, receives NF discovery requests from NF instances, and provides information of the discovered NF instances to the requesting NF instances. The NRF 754 also maintains NF profiles of available NF instances and their supported services. The NF profile of NF instance maintained in the NRF 754 includes the following information: NF instance ID; NF type; PLMN ID in the case of PLMN, PLMN ID+NID in the case of SNPN; Network Slice related Identifier(s) (e.g., S-NSSAI, NSI ID); an NF's network address(es) (e.g., FQDN, IP address, and/or the like), NF capacity information, NF priority information (e.g., for AMF selection), NF set ID, NF service set ID of the NF service instance; NF specific service authorization information; names of supported services, if applicable; endpoint address(es) of instance(s) of each supported service; identification of stored data/information (e.g., for UDR profile and/or other NF profiles); other service parameter(s) (e.g., DNN or DNN list, LADN DNN or LADN DNN list, notification endpoint for each type of notification that the NF service is interested in receiving, and/or the like); location information for the NF instance (e.g., geographical location, data center, and/or the like); TAI(s); NF load information; Routing Indicator, Home Network Public Key identifier, for UDM 758 and AUSF 742; for UDM 758, AUSF 742, and NSSAAF in the case of access to an SNPN using credentials owned by a Credentials Holder with AAA Server, identification of Credentials Holder (e.g., the realm of the Network Specific Identifier based SUPI); for UDM 758 and AUSF 742, and if UDM 758/AUSF 742 is used for access to an SNPN using credentials owned by a Credentials Holder, identification of Credentials Holder (e.g., the realm if network specific identifier based SUPI is used or the MCC and MNC if IMSI based SUPI is used); for AUSF 742 and NSSAAF in the case of SNPN Onboarding using a DCS with AAA server, identification of DCS (e.g., the realm of the Network Specific Identifier based SUPI); for UDM 758 and AUSF 742, and if UDM 758/AUSF 742is used as DCS in the case of SNPN Onboarding, identification of DCS ((e.g., the realm if Network Specific Identifier based SUPI, or the MCC and MNC if IMSI based SUPI); one or more GUAMI(s), in the case of AMF 744; for the UPF 748, see clause 5.2.7.2.2 of [TS23502]; UDM Group ID, range(s) of SUPIs, range(s) of GPSIs, range(s) of internal group identifiers, range(s) of external group identifiers for UDM 758; UDR Group ID, range(s) of SUPIs, range(s) of GPSIs, range(s) of external group identifiers for UDR; AUSF Group ID, range(s) of SUPIs for AUSF 742; PCF Group ID, range(s) of SUPIs for PCF 756; HSS Group ID, set(s) of IMPIs, set(s) of IMPU, set(s) of IMSIs, set(s) of PSIs, set(s) of MSISDN for HSS; event ID(s) supported by AFs 760, in the case of NEF 752; event Exposure service supported event ID(s) by UPF 748; application identifier(s) supported by AFs 760, in the case of NEF 752; range(s) of external identifiers, or range(s) of external group identifiers, or the domain names served by the NEF, in the case of NEF 752 (e.g., used when the NEF 752 exposes AF information for analytics purpose as detailed in [TS23288]; additionally the NRF 754 may store a mapping between UDM Group ID and SUPI(s), UDR Group ID and SUPI(s), AUSF Group ID and SUPI(s) and PCF Group ID and SUPI(s), to enable discovery of UDM 758, UDR, AUSF 742 and PCF 756 using SUPI, SUPI ranges as specified in clause 6.3 of [TS23501], and/or interact with UDR to resolve the UDM Group ID/UDR Group ID/AUSF Group ID/PCF Group ID based on UE identity (e.g., SUPI)); IP domain list as described in clause 6.1.6.2.21 of 3GPP TS 29.510 v18.2.0 (2023 Mar. 29) (“[TS29510]”), Range(s) of (UE) IPv4 addresses or Range(s) of (UE) IPv6 prefixes, Range(s) of SUPIs or Range(s) of GPSIs or a BSF Group ID, in the case of BSF; SCP Domain the NF belongs to; DCCF Serving Area information, NF types of the data sources, NF Set IDs of the data sources, if available, in the case of DCCF 763; supported DNAI list, in the case of SMF 746; for SNPN, capability to support SNPN Onboarding in the case of AMF and capability to support User Plane Remote Provisioning in the case of SMF 746; IP address range, DNAI for UPF 748; additional V2X related NF profile parameters are defined in 3GPP TS 23.287; additional ProSe related NF profile parameters are defined in 3GPP TS 23.304; additional MBS related NF profile parameters are defined in 3GPP TS 23.247; additional UAS related NF profile parameters are defined in TS 23.256; among many others discussed in [TS23501]. In some examples, service authorization information provided by an OAM system is also included in the NF profile in the case that, for example, an NF instance has an exceptional service authorization information.

For NWDAF 762, the NF profile includes: supported analytics ID(s), possibly per service, NWDAF serving area information (e.g., a list of TAIs for which the NWDAF can provide services and/or data), Supported Analytics Delay per Analytics ID (if available), NF types of the NF data sources, NF Set IDs of the NF data sources, if available, analytics aggregation capability (if available), analytics metadata provisioning capability (if available), ML model filter information parameters S-NSSAI(s) and area(s) of interest for the trained ML model(s) per analytics ID(s) (if available), federated learning (FL) capability type (e.g., FL server or FL client, if available), Time interval supporting FL (if available). The NWDAF's 762 Serving Area information is common to all its supported analytics IDs. The analytics IDs supported by the NWDAF 762 may be associated with a supported analytics delay, for example, the analytics report can be generated with a time (including data collection delay and inference delay) in less than or equal to the supported analytics delay. The determination of supported analytics delay, and how the NWDAF 762 avoid updating its Supported Analytics Delay in NRF frequently may be NWDAF-implementation specific.

The PCF 756 provides policy rules to control plane functions to enforce them, and may also support unified policy framework to govern network behavior. The PCF 756 may also implement a front end to access subscription information relevant for policy decisions in a UDR 759 of the UDM 758. In addition to communicating with functions over reference points as shown, the PCF 756 exhibit an Npcf service-based interface.

The UDM 758 handles subscription-related information to support the network entities' handling of communication sessions, and stores subscription data of UE 702. For example, subscription data may be communicated via an N8 reference point between the UDM 758 and the AMF 744. The UDM 758 may include two parts, an application front end and a UDR. The UDR may store subscription data and policy data for the UDM 758 and the PCF 756, and/or structured data for exposure and application data (including PFDs for application detection, application request information for multiple UEs 702) for the NEF 752. The Nudr service-based interface may be exhibited by the UDR to allow the UDM 758, PCF 756, and NEF 752 to access a particular set of the stored data, as well as to read, update (e.g., add, modify), delete, and subscribe to notification of relevant data changes in the UDR. The UDM 758 may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 758 may exhibit the Nudm service-based interface.

Edge Application Server Discovery Function (EASDF) 761 exhibits an Neasdf service-based interface, and is connected to the SMF 746 via an N88 interface. One or multiple EASDF instances may be deployed within a PLMN, and interactions between 5GC NF(s) and the EASDF 761 take place within a PLMN. The EASDF 761 includes one or more of the following functionalities: registering to NRF 754 for EASDF 761 discovery and selection; handling the DNS messages according to the instruction from the SMF 746; and/or terminating DNS security, if used. Handling the DNS messages according to the instruction from the SMF 746 includes one or more of the following functionalities: receiving DNS message handling rules and/or BaselineDNSPattern from the SMF 746; exchanging DNS messages from/with the UE 702; forwarding DNS messages to C-DNS or L-DNS for DNS query; adding EDNS client subnet (ECS) option into DNS query for an FQDN; reporting to the SMF 746 the information related to the received DNS messages; and/or buffering/discarding DNS messages from the UE 702 or DNS Server. The EASDF has direct user plane connectivity (e.g., without any NAT) with the PSA UPF over N6 for the transmission of DNS signaling exchanged with the UE. The deployment of a NAT between EASDF 761 and PSA UPF 748 may or may not be supported. Additional aspects of the EASDF 761 are discussed in [TS23548].

AF 760 provides application influence on traffic routing, provide access to NEF 752, and interact with the policy framework for policy control. The AF 760 may influence UPF 748 (re)selection and traffic routing. Based on operator deployment, when AF 760 is considered to be a trusted entity, the network operator may permit AF 760 to interact directly with relevant NFs. In some implementations, the AF 760 is used for edge computing implementations.

An NF that needs to collect data from an AF 760 may subscribe/unsubscribe to notifications regarding data collected from an AF 760, either directly from the AF 760 or via NEF 752. The data collected from an AF 760 is used as input for analytics by the NWDAF 762. The details for the data collected from an AF 760 as well as interactions between NEF 752, AF 760 and NWDAF 762 are described in [TS23288].

The 5GC 740 may enable edge computing by selecting operator/3rd party services to be geographically close to a point that the UE 702 is attached to the network. This may reduce latency and load on the network. In edge computing implementations, the 5GC 740 may select a UPF 748 close to the UE 702 and execute traffic steering from the UPF 748 to DN 736 via the N6 interface. This may be based on the UE subscription data, UE location, and information provided by the AF 760, which allows the AF 760 to influence UPF (re)selection and traffic routing.

The data network (DN) 736 may represent various network operator services, Internet access, or third party services that may be provided by one or more servers including, for example, application (app)/content server 738. The DN 736 may be an operator external public, a private PDN, or an intra-operator packet data network, for example, for provision of IMS services. In this example, the app server 738 can be coupled to an IMS via an S-CSCF or the I-CSCF. In some implementations, the DN 736 may represent one or more local area DNs (LADNs), which are DNs 736 (or DN names (DNNs)) that is/are accessible by a UE 702 in one or more specific areas. Outside of these specific areas, the UE 702 is not able to access the LADN/DN 736.

Additionally or alternatively, the DN 736 may be an edge DN 736, which is a (local) DN that supports the architecture for enabling edge applications. In these examples, the app server 738 may represent the physical hardware systems/devices providing app server functionality and/or the application software resident in the cloud or at an edge compute node that performs server function(s). In some examples, the app/content server 738 provides an edge hosting environment that provides support required for Edge Application Server's execution.

The interfaces of the 5GC 740 include reference points and service-based interfaces. The reference points include: N1 (between the UE 702 and the AMF 744), N2 (between RAN 714 and AMF 744), N3 (between RAN 714 and UPF 748), N4 (between the SMF 746 and UPF 748), N5 (between PCF 756 and AF 760), N6 (between UPF 748 and DN 736), N7 (between SMF 746 and PCF 756), N8 (between UDM 758 and AMF 744), N9 (between two UPFs 748), N10 (between the UDM 758 and the SMF 746), N11 (between the AMF 744 and the SMF 746), N12 (between AUSF 742 and AMF 744), N13 (between AUSF 742 and UDM 758), N14 (between two AMFs 744; not shown), N15 (between PCF 756 and AMF 744 in case of a non-roaming scenario, or between the PCF 756 in a visited network and AMF 744 in case of a roaming scenario), N16 (between two SMFs 746; not shown), and N22 (between AMF 744 and NSSF 750). Other reference point representations not shown in FIG. 7 can also be used. The service-based representation of FIG. 7 represents NFs within the control plane that enable other authorized NFs to access their services. The service-based interfaces (SBIs) include: Namf (SBI exhibited by AMF 744), Nsmf (SBI exhibited by SMF 746), Nnef (SBI exhibited by NEF 752), Npcf (SBI exhibited by PCF 756), Nudm (SBI exhibited by the UDM 758), Naf (SBI exhibited by AF 760), Nnrf (SBI exhibited by NRF 754), Nnssf (SBI exhibited by NSSF 750), Nausf (SBI exhibited by AUSF 742). Other service-based interfaces (e.g., Nudr, N5g-eir, and Nudsf) not shown in FIG. 7 can also be used. In some examples, the NEF 752 can provide an interface to edge compute nodes 736, which can be used to process wireless connections with the RAN 714.

Although not shown by FIG. 7, the network 700 may also include NFs that are not shown such as, for example, UDR, Unstructured Data Storage Function (UDSF), Network Slice Admission Control Function (NSACF), Network Slice-specific and Stand-alone Non-Public Network (SNPN) Authentication and Authorization Function (NSSAAF), UE radio Capability Management Function (UCMF), 5G-Equipment Identity Register (5G-EIR), CHarging Function (CHF), Time Sensitive Networking (TSN) AF 760, Time Sensitive Communication and Time Synchronization Function (TSCTSF), Data Collection Coordination Function (DCCF), Analytics Data Repository Function (ADRF), Messaging Framework Adaptor Function (MFAF), Binding Support Function (BSF), Non-Seamless WLAN Offload Function (NSWOF), Service Communication Proxy (SCP), Security Edge Protection Proxy (SEPP), Non-3GPP InterWorking Function (N3IWF), Trusted Non-3GPP Gateway Function (TNGF), Wireline Access Gateway Function (W-AGF), and/or Trusted WLAN Interworking Function (TWIF) as discussed in [TS23501].

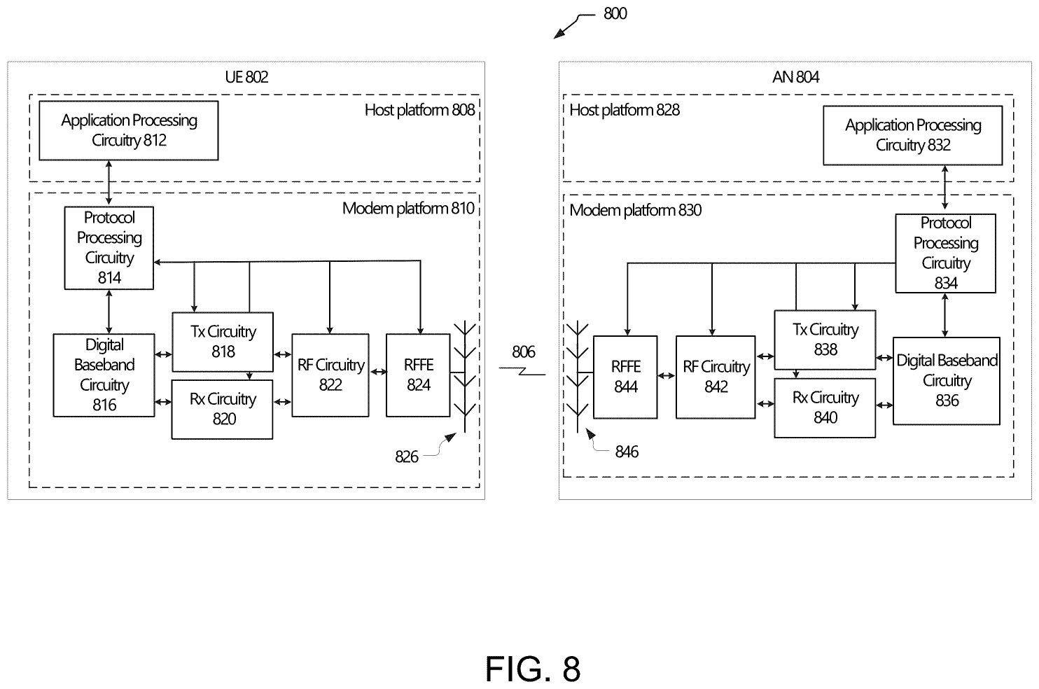

FIG. 8 schematically illustrates a wireless network 800. The wireless network 800 includes a UE 802 in wireless communication with an AN 804. The UE 802 and AN 804 may be similar to, and substantially interchangeable with, like-named components described elsewhere herein.

The UE 802 may be communicatively coupled with the AN 804 via connection 806. The connection 806 is illustrated as an air interface to enable communicative coupling, and can be consistent with cellular communications protocols such as an LTE protocol or a 5G NR protocol operating at mmWave or sub-6GHz frequencies.

The UE 802 includes a host platform 808 coupled with a modem platform 810. The host platform 808 includes application processing circuitry 812, which may be coupled with protocol processing circuitry 814 of the modem platform 810. The application processing circuitry 812 may run various applications for the UE 802 that source/sink application data. The application processing circuitry 812 may further implement one or more layer operations to transmit/receive application data to/from a data network. These layer operations includes transport (for example UDP) and Internet (for example, IP) operations

The protocol processing circuitry 814 may implement one or more of layer operations to facilitate transmission or reception of data over the connection 806. The layer operations implemented by the protocol processing circuitry 814 includes, for example, MAC, RLC, PDCP, RRC and NAS operations.

The modem platform 810 may further include digital baseband circuitry 816 that may implement one or more layer operations that are “below” layer operations performed by the protocol processing circuitry 814 in a network protocol stack. These operations includes, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which includes one or more of space-time, space-frequency or spatial coding, reference signal generation/detection, preamble sequence generation and/or decoding, synchronization sequence generation/detection, control channel signal blind decoding, and other related functions.

The modem platform 810 may further include transmit circuitry 818, receive circuitry 820, RF circuitry 822, and RF front end (RFFE) 824, which includes or connect to one or more antenna panels 826. Briefly, the transmit circuitry 818 includes a digital-to-analog converter, mixer, intermediate frequency (IF) components, and/or the like; the receive circuitry 820 includes an analog-to-digital converter, mixer, IF components, and/or the like; the RF circuitry 822 includes a low-noise amplifier, a power amplifier, power tracking components, and/or the like; RFFE 824 includes filters (for example, surface/bulk acoustic wave filters), switches, antenna tuners, beamforming components (for example, phase-array antenna components), and/or the like. The selection and arrangement of the components of the transmit circuitry 818, receive circuitry 820, RF circuitry 822, RFFE 824, and antenna panels 826 (referred generically as “transmit/receive components”) may be specific to details of a specific implementation such as, for example, whether communication is TDM or FDM, in mmWave or sub-6 gHz frequencies, and/or the like. In some examples, the transmit/receive components may be arranged in multiple parallel transmit/receive chains, may be disposed in the same or different chips/modules, and/or the like.

In some examples, the protocol processing circuitry 814 includes one or more instances of control circuitry (not shown) to provide control functions for the transmit/receive components.

A UE reception may be established by and via the antenna panels 826, RFFE 824, RF circuitry 822, receive circuitry 820, digital baseband circuitry 816, and protocol processing circuitry 814. In some examples, the antenna panels 826 may receive a transmission from the AN 804 by receive-beamforming signals received by a set of antennas/antenna elements of the one or more antenna panels 826.

A UE transmission may be established by and via the protocol processing circuitry 814, digital baseband circuitry 816, transmit circuitry 818, RF circuitry 822, RFFE 824, and antenna panels 826. In some examples, the transmit components of the UE 804 may apply a spatial filter to the data to be transmitted to form a transmit beam emitted by the antenna elements of the antenna panels 826.

Similar to the UE 802, the AN 804 includes a host platform 828 coupled with a modem platform 830. The host platform 828 includes application processing circuitry 832 coupled with protocol processing circuitry 834 of the modem platform 830. The modem platform may further include digital baseband circuitry 836, transmit circuitry 838, receive circuitry 840, RF circuitry 842, RFFE circuitry 844, and antenna panels 846. The components of the AN 804 may be similar to and substantially interchangeable with like-named components of the UE 802. In addition to performing data transmission/reception as described above, the components of the AN 808 may perform various logical functions that include, for example, RNC functions such as radio bearer management, uplink and downlink dynamic radio resource management, and data packet scheduling.

Examples of the antenna elements of the antenna panels 826 and/or the antenna elements of the antenna panels 846 include planar inverted-F antennas (PIFAs), monopole antennas, dipole antennas, loop antennas, patch antennas, Yagi antennas, parabolic dish antennas, omni-directional antennas, and/or the like.

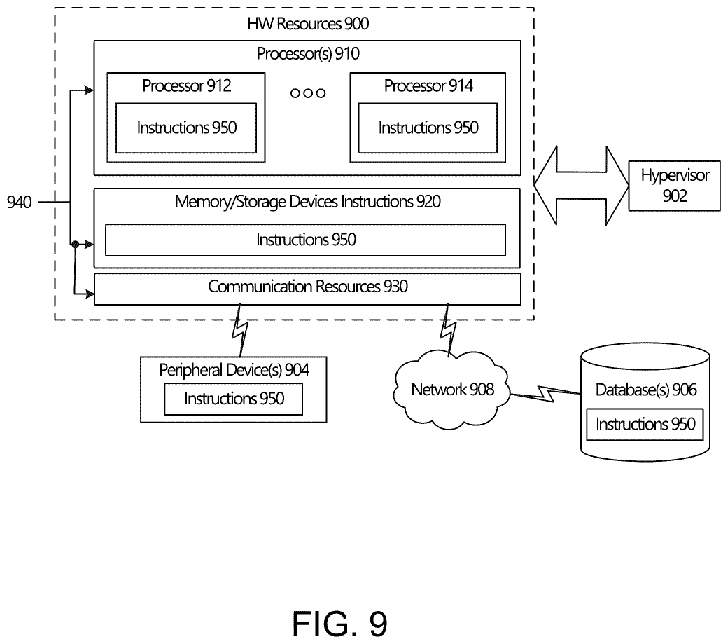

FIG. 9 illustrates components capable of reading instructions from a machine-readable or computer-readable medium (e.g., a non-transitory machine-readable storage medium) and perform any one or more of the methodologies discussed herein. Specifically, FIG. 9 shows hardware resources 900 including one or more processors (or processor cores) 910, one or more memory/storage devices 920, and one or more communication resources 930, each of which may be communicatively coupled via a bus 940 or other interface circuitry. For examples where node virtualization (e.g., NFV) is utilized, a hypervisor 902 may be executed to provide an execution environment for one or more network slices/sub-slices to utilize the hardware resources 900. In some examples, the hardware resources 900 may be implemented in or by an individual compute node, which may be housed in an enclosure of various form factors. In other examples, the hardware resources 900 may be implemented by multiple compute nodes that may be deployed in one or more data centers and/or distributed across one or more geographic regions.

The processors 910 may include, for example, a processor 912 and a processor 914. The processors 910 may be or include, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), a microprocessor or controller, a multi-core processor, a multithreaded processor, an ultra-low voltage processor, an embedded processor, an xPU, a data processing unit (DPU), an Infrastructure Processing Unit (IPU), a network processing unit (NPU), another processor (including any of those discussed herein), and/or any suitable combination thereof.

The memory/storage devices 920 may include main memory, disk storage, or any suitable combination thereof. The memory/storage devices 920 may include, but are not limited to, any type of volatile, non-volatile, semi-volatile memory, and/or any combination thereof. As examples, the memory/storage devices 920 can be or include random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, dual inline memory modules (DIMMs), microDIMMs, MiniDIMMs, block addressable memory device(s) (e.g., those based on NAND or NOR technologies (e.g., single-level cell (SLC), Multi-Level Cell (MLC), Quad-Level Cell (QLC), Tri-Level Cell (TLC), or some other NAND), read-only memory (ROM), programmable ROM (PROM), erasable PROM (EPROM), electrically EPROM (EEPROM), flash memory, non-volatile RAM (NVRAM), solid-state storage, magnetic disk storage mediums, optical storage mediums, memory devices that use chalcogenide glass, multi-threshold level NAND flash memory, NOR flash memory, single or multi-level Phase Change Memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a th11istor based memory device, and/or a combination of any of the aforementioned memory devices, and/or other memory.

The communication resources 930 may include interconnection or network interface controllers, components, or other suitable devices to communicate with one or more peripheral devices 904 or one or more databases 906 or other network elements via a network 908. For example, the communication resources 930 may include wired communication components (e.g., for coupling via USB, Ethernet, and/or the like), cellular communication components, NFC components, Bluetooth® (or Bluetooth® Low Energy) components, Wi-Fi® components, and other communication components.

Instructions 950 comprise software, program code, application(s), applet(s), an app(s), firmware, microcode, machine code, and/or other executable code for causing at least any of the processors 910 to perform any one or more of the methodologies and/or techniques discussed herein. The instructions 950 may reside, completely or partially, within at least one of the processors 910 (e.g., within the processor's cache memory), the memory/storage devices 920, or any suitable combination thereof. Furthermore, any portion of the instructions 950 may be transferred to the hardware resources 900 from any combination of the peripheral devices 904 or the databases 906. Accordingly, the memory of processors 910, the memory/storage devices 920, the peripheral devices 904, and the databases 906 are examples of computer-readable and machine-readable media.

In some examples, the peripheral devices 904 may represent one or more sensors (also referred to as “sensor circuitry”). The sensor circuitry includes devices, modules, or subsystems whose purpose is to detect events or changes in its environment and send the information (sensor data) about the detected events to some other a device, module, subsystem, and/or the like. Individual sensors may be exteroceptive sensors (e.g., sensors that capture and/or measure environmental phenomena and/external states), proprioceptive sensors (e.g., sensors that capture and/or measure internal states of a compute node or platform and/or individual components of a compute node or platform), and/or exproprioceptive sensors (e.g., sensors that capture, measure, or correlate internal states and external states). Examples of such sensors include, inter alia, inertia measurement units (IMU) comprising accelerometers, g11oscopes, and/or magnetometers; microelectromechanical systems (MEMS) or nanoelectromechanical systems (NEMS) comprising 3-axis accelerometers, 3-axis g11oscopes, and/or magnetometers; level sensors; flow sensors; temperature sensors (e.g., thermistors, including sensors for measuring the temperature of internal components and sensors for measuring temperature external to the compute node or platform); pressure sensors; barometric pressure sensors; gravimeters; altimeters; image capture devices (e.g., cameras); light detection and ranging (LiDAR) sensors; proximity sensors (e.g., infrared radiation detector and the like); depth sensors, ambient light sensors; optical light sensors; ultrasonic transceivers; microphones; and the like.

Additionally or alternatively, the peripheral devices 904 may represent one or more actuators, which allow a compute node, platform, machine, device, mechanism, system, or other object to change its state, position, and/or orientation, or move or control a compute node, platform, machine, device, mechanism, system, or other object. The actuators comprise electrical and/or mechanical devices for moving or controlling a mechanism or system, and converts energy (e.g., electric current or moving air and/or liquid) into some kind of motion. As examples, the actuators can be or include any number and combination of the following: soft actuators (e.g., actuators that changes its shape in response to a stimuli such as, for example, mechanical, thermal, magnetic, and/or electrical stimuli), hydraulic actuators, pneumatic actuators, mechanical actuators, electromechanical actuators (EMAs), microelectromechanical actuators, electrohydraulic actuators, linear actuators, linear motors, rotary motors, DC motors, stepper motors, servomechanisms, electromechanical switches, electromechanical relays (EMRs), power switches, valve actuators, piezoelectric actuators and/or biomorphs, thermal biomorphs, solid state actuators, solid state relays (SSRs), shape-memory alloy-based actuators, electroactive polymer-based actuators, relay driver integrated circuits (ICs), solenoids, impactive actuators/mechanisms (e.g., jaws, claws, tweezers, clamps, hooks, mechanical fingers, humaniform dexterous robotic hands, and/or other gripper mechanisms that physically grasp by direct impact upon an object), propulsion actuators/mechanisms (e.g., wheels, axles, thrusters, propellers, engines, motors (e.g., those discussed previously), clutches, and the like), projectile actuators/mechanisms (e.g., mechanisms that shoot or propel objects or elements), and/or audible sound generators, visual warning devices, and/or other like electromechanical components. Additionally or alternatively, the actuators can include virtual instrumentation and/or virtualized actuator devices. Additionally or alternatively, the actuators can include various controller and/or components of the compute node or platform (or components thereof) such as, for example, host controllers, cooling element controllers, baseboard management controller (BMC), platform controller hub (PCH), uncore components (e.g., shared last level cache (LLC) cache, caching agent (Cbo), integrated memory controller (IMC), home agent (HA), power control unit (PCU), configuration agent (Ubox), integrated I/O controller (IIO), and interconnect (IX) link interfaces and/or controllers), and/or any other components such as any of those discussed herein. The compute node or platform may be configured to operate one or more actuators based on one or more captured events, instructions, control signals, and/or configurations received from a service provider, client device, and/or other components of a compute node or platform. Additionally or alternatively, the actuators are used to change the operational state (e.g., on/off, zoom or focus, and/or the like), position, and/or orientation of the sensors.

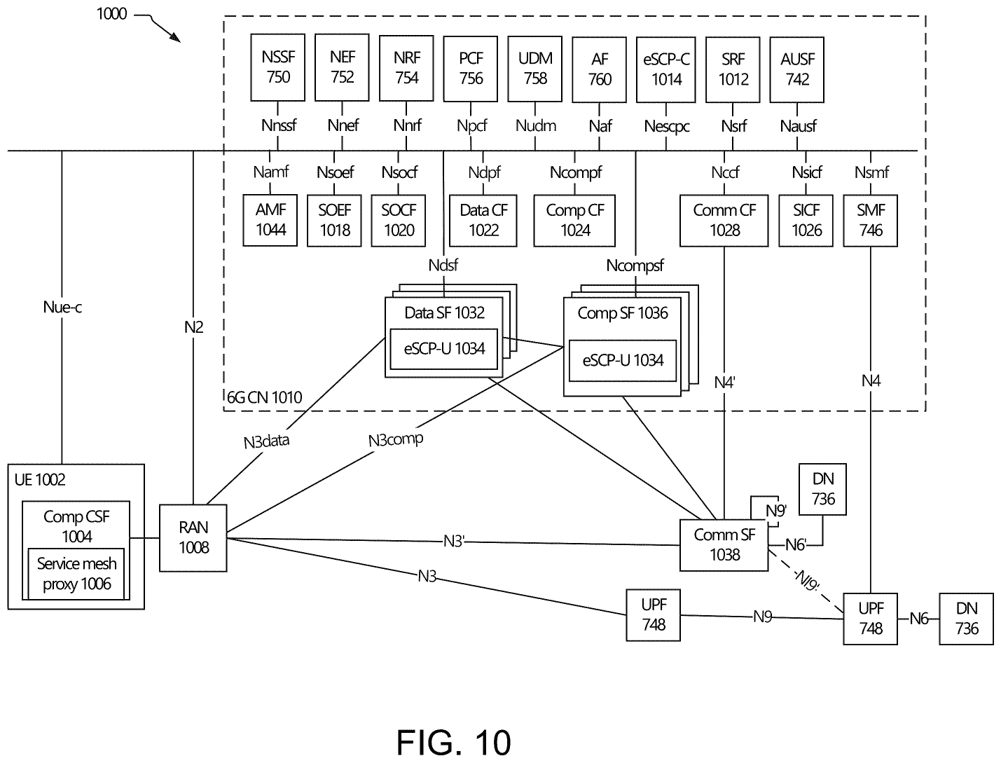

FIG. 10 illustrates an example cellular network 1000, in accordance with one or more embodiments of the present disclosure.

The network 1000 may operate in a matter consistent with 3GPP technical specifications or technical reports for 6G systems. In some examples, the network 1000 may operate concurrently with network 700. For example, in some examples, the network 1000 may share one or more frequency or bandwidth resources with network 700. As one specific example, a UE (e.g., UE 1002) may be configured to operate in both network 1000 and network 700. Such configuration may be based on a UE including circuitry configured for communication with frequency and bandwidth resources of both networks 700 and 1000. In general, several elements of network 1000 may share one or more characteristics with elements of network 700. For the sake of brevity and clarity, such elements may not be repeated in the description of network 1000.

The network 1000 may include a UE 1002, which may include any mobile or non-mobile computing device designed to communicate with a RAN 1008 via an over-the-air connection. The UE 1002 may be similar to, for example, UE 702. The UE 1002 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, and/or the like.

Although not specifically shown in FIG. 10, in some examples the network 1000 may include a set of UEs coupled directly with one another via a sidelink interface. The UEs may be M2M/D2D devices that communicate using physical sidelink channels such as, but not limited to, PSBCH, PSDCH, PSSCH, PSCCH, PSFCH, and/or the like. Similarly, although not specifically shown in FIG. 10, the UE 1002 may be communicatively coupled with an AP such as AP 706 as described with respect to FIG. 7. Additionally, although not specifically shown in FIG. 10, in some examples the RAN 1008 may include one or more ANs such as AN 708 as described with respect to FIG. 7. The RAN 1008 and/or the AN of the RAN 1008 may be referred to as a base station (BS), a RAN node, or using some other term or name.

The UE 1002 and the RAN 1008 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 1008 may allow for communication between the UE 1002 and a 6G core network (CN) 1010. Specifically, the RAN 1008 may facilitate the transmission and reception of data between the UE 1002 and the 6G CN 1010. The 6G CN 1010 may include various functions such as NSSF 750, NEF 752, NRF 754, PCF 756, UDM 758, AF 760, SMF 746, and AUSF 742. The 6G CN 1010 may additional include UPF 748 and DN 736 as shown in FIG. 10.

Additionally, the RAN 1008 may include various additional functions that are in addition to, or alternative to, functions of a legacy cellular network such as a 4G or 5G network. Two such functions may include a Compute Control Function (Comp CF) 1024 and a Compute Service Function (Comp SF) 1036. The Comp CF 1024 and the Comp SF 1036 may be parts or functions of the Computing Service Plane. Comp CF 1024 may be a control plane function that provides functionalities such as management of the Comp SF 1036, computing task context generation and management (e.g., create, read, modify, delete), interaction with the underlaying computing infrastructure for computing resource management, and/or the like. Comp SF 1036 may be a user plane function that serves as the gateway to interface computing service users (such as UE 1002) and computing nodes behind a Comp SF instance. Some functionalities of the Comp SF 1036 may include: parse computing service data received from users to compute tasks executable by computing nodes; hold service mesh ingress gateway or service API gateway; service and charging policies enforcement; performance monitoring and telemetry collection, and/or the like. In some examples, a Comp SF 1036 instance may serve as the user plane gateway for a cluster of computing nodes. A Comp CF 1024 instance may control one or more Comp SF 1036 instances.

Two other such functions may include a Communication Control Function (Comm CF) 1028 and a Communication Service Function (Comm SF) 1038, which may be parts of the Communication Service Plane. The Comm CF 1028 may be the control plane function for managing the Comm SF 1038, communication sessions creation/configuration/releasing, and managing communication session context. The Comm SF 1038 may be a user plane function for data transport. Comm CF 1028 and Comm SF 1038 may be considered as upgrades of SMF 746 and UPF 748, which were described with respect to a 5G system in FIG. 7. The upgrades provided by the Comm CF 1028 and the Comm SF 1038 may enable service-aware transport. For legacy (e.g., 4G or 5G) data transport, SMF 746 and UPF 748 may still be used.

Two other such functions may include a Data Control Function (Data CF) 1022 and Data Service Function (Data SF) 1032 may be parts of the Data Service Plane. Data CF 1022 may be a control plane function and provides functionalities such as Data SF 1032 management, Data service creation/configuration/releasing, Data service context management, and/or the like. Data SF 1032 may be a user plane function and serve as the gateway between data service users (such as UE 1002 and the various functions of the 6G CN 1010) and data service endpoints behind the gateway. Specific functionalities may include include: parse data service user data and forward to corresponding data service endpoints, generate charging data, report data service status.

Another such function may be the Service Orchestration and Chaining Function (SOCF) 1020, which may discover, orchestrate and chain up communication/computing/data services provided by functions in the network. Upon receiving service requests from users, SOCF 1020 may interact with one or more of Comp CF 1024, Comm CF 1028, and Data CF 1022 to identify Comp SF 1036, Comm SF 1038, and Data SF 1032 instances, configure service resources, and generate the service chain, which could contain multiple Comp SF 1036, Comm SF 1038, and Data SF 1032 instances and their associated computing endpoints. Workload processing and data movement may then be conducted within the generated service chain. The SOCF 1020 may also responsible for maintaining, updating, and releasing a created service chain.

Another such function may be the service registration function (SRF) 1012, which may act as a registry for system services provided in the user plane such as services provided by service endpoints behind Comp SF 1036 and Data SF 1032 gateways and services provided by the UE 1002. The SRF 1012 may be considered a counterpart of NRF 754, which may act as the registry for network functions.

Other such functions may include an evolved service communication proxy (eSCP) and service infrastructure control function (SICF) 1026, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 1012 and eSCP-U 1034, for control plane service communication proxy and user plane service communication proxy, respectively. The SICF 1026 may control and configure eCSP instances in terms of service traffic routing policies, access rules, load balancing configurations, performance monitoring, and/or the like.

Another such function is the AMF 1044. The AMF 1044 may be similar to 744, but with additional functionality. Specifically, the AMF 1044 may include potential functional repartition, such as move the message forwarding functionality from the AMF 1044 to the RAN 1008.

Another such function is the service orchestration exposure function (SOEF) 1018. The SOEF may be configured to expose service orchestration and chaining services to external users such as applications.

The UE 1002 may include an additional function that is referred to as a computing client service function (comp CSF) 1004. The comp CSF 1004 may have both the control plane functionalities and user plane functionalities, and may interact with corresponding network side functions such as SOCF 1020, Comp CF 1024, Comp SF 1036, Data CF 1022, and/or Data SF 1032 for service discovery, request/response, compute task workload exchange, and/or the like. The Comp CSF 1004 may also work with network side functions to decide on whether a computing task should be run on the UE 1002, the RAN 1008, and/or an element of the 6G CN 1010.

The UE 1002 and/or the Comp CSF 1004 may include a service mesh proxy 1006. The service mesh proxy 1006 may act as a proxy for service-to-service communication in the user plane. Capabilities of the service mesh proxy 1006 may include one or more of addressing, security, load balancing, and/or the like.

FIG. 11 shows example network deployments including an example next generation fronthaul (NGF) deployment 1100a where a user equipment (UE) 1102 is connected to an RU 1130 (also referred to as a “remote radio unit 1130”, “a remote radio head 1130”, or “RRH 1130”) via an air interface, the RU 1130 is connected to a Digital Unit (DU) 1131 via a NGF interface (NGFI)-I, the DU 1131 is connected to a Central Unit (CU) 1132 via an NGFI-II, and the CU 1132 is connected to a core network (CN) 1142 via a backhaul interface. In 3GPP NG-RAN implementations (see e.g., [TS38401]), the DU 1131 may be a distributed unit (for purposes of the present disclosure, the term “DU” may refer to a digital unit and/or a distributed unit unless the context dictates otherwise). The UEs 1102 may be the same or similar to, and/or share one or more features with UE 702, UE 802, hardware resources 900, UE 1002, UE 1105, and/or any other UE described herein.

In some implementations, the NGF deployment 1100a may be arranged in a distributed RAN (D-RAN) architecture where the CU 1132, DU 1131, and RU 1130 reside at a cell site and the CN 1142 is located at a centralized site. Alternatively, the NGF deployment 1100a may be arranged in a centralized RAN (C-RAN) architecture with centralized processing of one or more baseband units (BBUs) at the centralized site.

The CU 1132 is a central controller that can serve or otherwise connect to one or multiple DUs 1131 and/or multiple RUs 1130. The CU 1132 is network (logical) nodes hosting higher/upper layers of a network protocol functional split.

A CU 1132 may include a CU-control plane (CP) entity (referred to herein as “CU-CP 1132”) and a CU-user plane (UP) entity (referred to herein as “CU-UP 1132”). The CU-CP 1132 is a logical node hosting the RRC layer and the control plane part of the PDCP protocol layer of the CU 1132 (e.g., a gNB-CU for an en-gNB or a gNB).

The DU 1131 controls radio resources, such as time and frequency bands, locally in real time, and allocates resources to one or more UEs. The DUs 1131 are network (logical) nodes hosting middle and/or lower layers of the network protocol functional split.

The RU 1130 is a transmission/reception point (TRP) or other physical node that handles radiofrequency (RF) processing functions. The RU 1130 is a network (logical) node hosting lower layers based on a lower layer functional split. For example, in 3GPP NG-RAN and/or O-RAN architectures, the RU 1130 hosts low-PHY layer functions and RF processing of the radio interface based on a lower layer functional split. The RU 1130 may be similar to 3GPP's transmission/reception point (TRP) or RRH, but specifically includes the Low-PHY layer. Examples of the low-PHY functions include fast Fourier transform (FFT), inverse FFT (iFFT), physical random access channel (PRACH) extraction, and the like.

Each of the CUs 1132, DUs 1131, and RUs 1130 are connected through respective links, which may be any suitable wireless and/or wired (e.g., fiber, copper, and the like) links.

In one example, the deployment 1100a may implement a low level split (LLS) (also referred to as a “Lower Layer Functional Split 7-2x” or “Split Option 7-2x”) that runs between the RU 1130 (e.g., an O-RU in O-RAN architectures) and the DU 1131 (e.g., an O-DU in O-RAN architectures) (see e.g., [ORAN.IPC-HRD-Opt7-2], [ORAN.OMAC-HRD], [ORAN.OMC-HRD-Opt7-2], [ORAN.OMC-HRD-Opt7-2]).

FIG. 11 also shows an example RAN disaggregation deployment 1100b (also referred to as “disaggregated RAN 1100b”) where the UE 1102 is connected to the RRH 1130, and the RRH 1130 is communicatively coupled with one or more of the RAN functions (RANFs) 1-N (where N is a number).

Network disaggregation (or disaggregated networking) involves the separation of networking equipment into functional components and allowing each component to be individually deployed. This may encompass separation of SW elements (e.g., NFs) from specific HW elements and/or using APIs to enable software defined network (SDN) and/or and NF virtualization (NFV). RAN disaggregation involves network disaggregation and virtualization of various RANFs (e.g., RANFs 1-N in FIG. 11).

FIG. 11 also shows various functional split options 1100c, for both DL and UL directions.

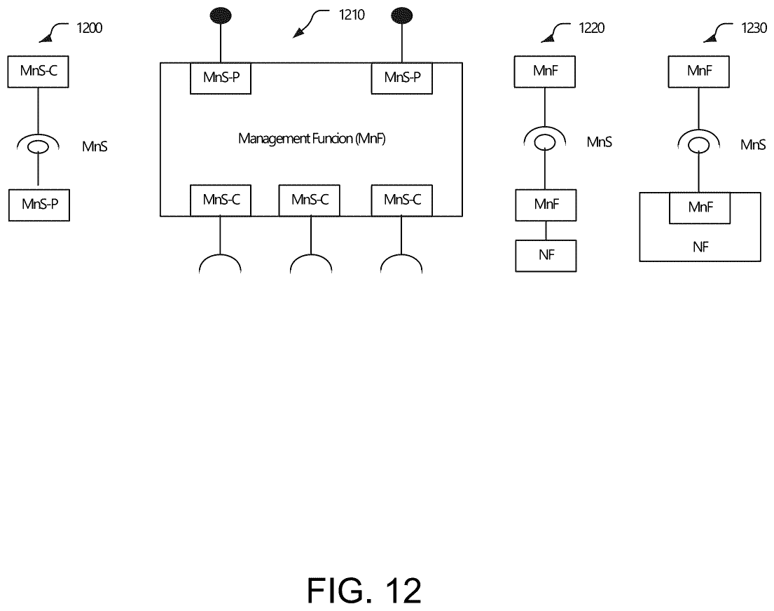

FIG. 12 depicts an example of management services (MnS) deployment 1200, in accordance with one or more example embodiments of the present disclosure.

MnS is a Service Based Management Architecture (SBMA). An MnS is a set of offered management capabilities (e.g., capabilities for management and orchestration (MANO) of network and services). The entity producing an MnS is referred to as an MnS producer (MnS-P) and the entity consuming an MnS is referred to as an MnS consumer (MnS-C). An MnS provided by an MnS-P can be consumed by any entity with appropriate authorization and authentication. As shown by FIG. 1, the MnS-P offers its services via a standardized service interface composed of individually specified MnS components (e.g., MnS-C).

A MnS is specified using different independent components. A concrete MnS includes at least two of these components. Three different component types are defined, including MnS component type A, MnS component type B, and MnS component type C. An MnS component type A is a group of management operations and/or notifications that is agnostic with regard to the entities managed. The operations and notifications as such are hence not involving any information related to the managed network. These operations and notifications are called generic or network agnostic. For example, operations for creating, reading, updating and deleting managed object instances, where the managed object instance to be manipulated is specified only in the signature of the operation, are generic. An MnS component type B refers to management information represented by information models representing the managed entities. An MnS component type B is also called Network Resource Model (NRM) (see e.g., [TS28622], [TS28541]). MnS component type C is performance information of the managed entity and fault information of the managed entity. Examples of management service component type C include alarm information (see e.g., [TS28532] and [TS28545]) and performance data (see e.g., [TS28552], [TS28554], and [TS32425]).

An MnS-P is described by a set of metadata called MnS-P profile. The profile holds information about the supported MnS components and their version numbers. This may include also information about support of optional features. For example, a read operation on a complete subtree of managed object instances may support applying filters on the scoped set of objects as optional feature. In this case, the MnS profile should include the information if filtering is supported.

FIG. 12 also depicts an example management function (MnF) deployment 1210. The MnF is a logical entity playing the roles of MnS-C and/or MnS-P. An MnF with the role of management service exposure governance is referred to as an “Exposure governance management function” or “exposure governance MnF”. An MnS produced by an MnF 1210 may have multiple consumers. The MnF 1210 may consume multiple MnS from one or multiple MnS-Ps. In the MnF deployment 1210, the MnF plays both roles (e.g., MnS-P and MnS-C). An MnF can be deployed as a separate entity or embedded in a network function (NF) to provide MnS(s). For example, MnF deployment scenario 1220 shows an example where the MnF is deployed as a separate entity to provide MnS(s) and MnF deployment scenario 1230 in which an MnF is embedded in an NF to provide MnS(s). In these examples, the MnFs may interact by consuming MnS produced by other MnFs

The 3GPP management system is also capable to consume NFV MANO interface (e.g., Os-Ma-nfvo, Ve-Vnfm-em, and Ve-Vnfm-vnf reference points). An MnS-P can consume management interfaces provided by NFV MANO for at least the following purposes: network service LCM; and VNF LCM, PM, FM, CM on resources supporting VNF.

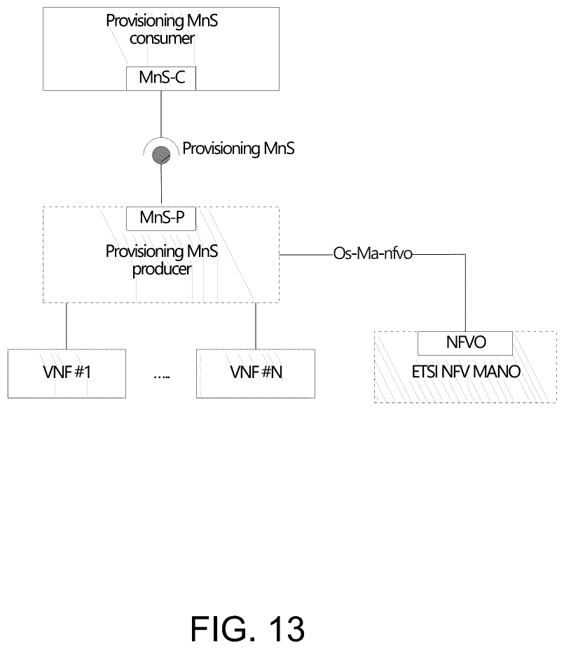

FIG. 13 shows an example framework of provisioning MnS where an MnS-P interfaces to an ETSI NFV MANO to support lifecycle management of VNFs.

Machine learning (ML) involves programming computing systems to optimize a performance criterion using example (training) data and/or past experience. ML refers to the use and development of computer systems that are able to learn and adapt without following explicit instructions, by using algorithms and/or statistical models to analyze and draw inferences from patterns in data. ML involves using algorithms to perform specific task(s) without using explicit instructions to perform the specific task(s), but instead relying on learnt patterns and/or inferences. ML uses statistics to build mathematical model(s) (also referred to as “ML models” or simply “models”) in order to make predictions or decisions based on sample data (e.g., training data). The model is defined to have a set of parameters, and learning is the execution of a computer program to optimize the parameters of the model using the training data or past experience. The trained model may be a predictive model that makes predictions based on an input dataset, a descriptive model that gains knowledge from an input dataset, or both predictive and descriptive. Once the model is learned (trained), it can be used to make inferences (e.g., predictions).

FIG. 14 depicts an example AI/ML-assisted communication network, in accordance with one or more embodiments of the present disclosure.

The AI/ML-assisted communication network includes communication between an ML function (MLF) 1402 and an MLF 1404. More specifically, as described in further detail below, AI/ML models may be used or leveraged to facilitate wired and/or over-the-air communication between the MLF 1402 and the MLF 1404. In this example, the MLF 1402 and the MLF 1404 operate in a matter consistent with 3GPP technical specifications and/or technical reports for 5G and/or 6G systems. In some examples, the communication mechanisms between the MLF 1402 and the MLF 1404 include any suitable access technologies and/or RATs, such as any of those discussed herein. Additionally, the communication mechanisms in FIG. 14 may be part of, or operate concurrently with the components, devices, systems, networks, and/or deployments of FIGS. 1, 2, 3, 4, 7, 8, 10, 11, 12-13, and/or some other components, devices, systems, networks, and/or deployments described herein.

The MLFs 1402, 1404 may correspond to any of the entities/elements discussed herein. In one example, the MLF 1402 corresponds to an MnF and/or MnS-P and the MLF 1404 corresponds to a consumer 310, an MnS-C, or vice versa. Additionally or alternatively, the MLF 1402 corresponds to a set of the MLFs of FIGS. 12-13 and the MLF 1404 corresponds to a different set of the MLFs of FIGS. 12-13. In this example, the sets of MLFs may be mutually exclusive, or some or all of the MLFs in each of the sets of MLFs may overlap or be shared. In another example, the MLF 1402 and/or the MLF 1404 is/are implemented by respective UEs (e.g., UE 702, UE 802). Additionally or alternatively, the MLF 1402 and/or the MLF 1404 is/are implemented by a same UE or different UEs. In another example, the MLF 1402 and/or the MLF 1404 is/are implemented by respective RANs (e.g., RAN 704) or respective NANs (e.g., AP 706, NAN 714, NAN 804).

As shown by FIG. 14, the MLF 1402 and the MLF 1404 include various AI/ML-related components, functions, elements, or entities, which may be implemented as hardware, software, firmware, and/or some combination thereof. In some examples, one or more of the AI/ML-related elements are implemented as part of the same hardware (e.g., IC, chip, or multi-processor chip), software (e.g., program, process, engine, and/or the like), or firmware as at least one other component, function, element, or entity. The AI/ML-related elements of MLF 1402 may be the same or similar to the AI/ML-related elements of MLF 1404. For the sake of brevity, description of the various elements is provided from the point of view of the MLF 1402, however it will be understood that such description applies to like named/numbered elements of MLF 1404, unless explicitly stated otherwise.

The data repository 1415 is responsible for data collection and storage. As examples, the data repository 1415 may collect and store RAN configuration parameters, NF configuration parameters, measurement data, RLM data, key performance indicators (KPIs), SLAs, model performance metrics, knowledge base data, ground truth data, ML model parameters, hyperparameters, and/or other data for model training, update, and inference. In some examples, a data collection function (not shown) is part or connected to the data repository 1415. The data collection function is a function that provides input data to the MLTF 1425 and model inference function 1445. AI/ML algorithm-specific data preparation (e.g., data pre-processing and cleaning, formatting, and transformation) may or may not be carried out in the data collection function 1605. Examples of input data may include measurements from UEs 702, RAN nodes 714, and/or additional or alternative network entities; feedback from actor 1620; and/or output(s) from AI/ML model(s). The input data fed to the MLTF 1425 is training data, and the input data fed to the model inference function 1445 is inference data.

The collected data is stored in/by the repository 1415, and the stored data can be discovered and extracted by other elements from the data repository 1415. For example, the inference data selection/filter 1450 may retrieve data from the data repository 1415 and provide that data to the inference engine 1445 for generating/determining inferences. In various examples, the MLF 1402 is configured to discover and request data from the data repository 1415 in the MLF 1404, and/or vice versa. In these examples, the data repository 1415 of the MLF 1402 may be communicatively coupled with the data repository 1415 of the MLF 1404 such that the respective data repositories 1415 may share collected data with one another. Additionally or alternatively, the MLF 1402 and/or MLF 1404 is/are configured to discover and request data from one or more external sources and/or data storage systems/devices.

The training data selection/filter 1420 is configured to generate training, validation, and testing datasets for ML training (MLT) (or ML model training). One or more of these datasets may be extracted or otherwise obtained from the data repository 1415. Data may be selected/filtered based on the specific AI/ML model to be trained. Data may optionally be transformed, augmented, and/or pre-processed (e.g., normalized) before being loaded into datasets. The training data selection/filter 1420 may label data in datasets for supervised learning, or the data may remain unlabeled for unsupervised learning. The produced datasets may then be fed into the MLT function (MLTF) 1425.

The MLTF 1425 is responsible for training and updating (e.g., tuning and/or re-training) AI/ML models. A selected model (or set of models) may be trained using the fed-in datasets (including training, validation, testing) from the training data selection/filtering 1420. The MLTF 1425 produces trained and tested AI/ML models that are ready for deployment. The produced trained and tested models can be stored in a model repository 1435. Additionally or alternatively, the MLTF 1425 performs AI/ML model training, validation, and testing. The MLTF 1425 may generate model performance metrics as part of the model testing procedure and/or as part of the model validation procedure. Examples of the model performance metrics are discussed infra. The MLTF 1425 may also be responsible for data preparation (e.g., data pre-processing and cleaning, formatting, and transformation) based on training data delivered by the data collection function and/or the training data selection/filter 1420, if required. The MLTF 1425 performs model deployment/updates, wherein the MLTF 1425 initially deploys a trained, validated, and tested AI/ML model to the model inference function 1445, and/or delivers updated model(s) to the model inference function 1445. Examples of the model deployments and updates are discussed infra.

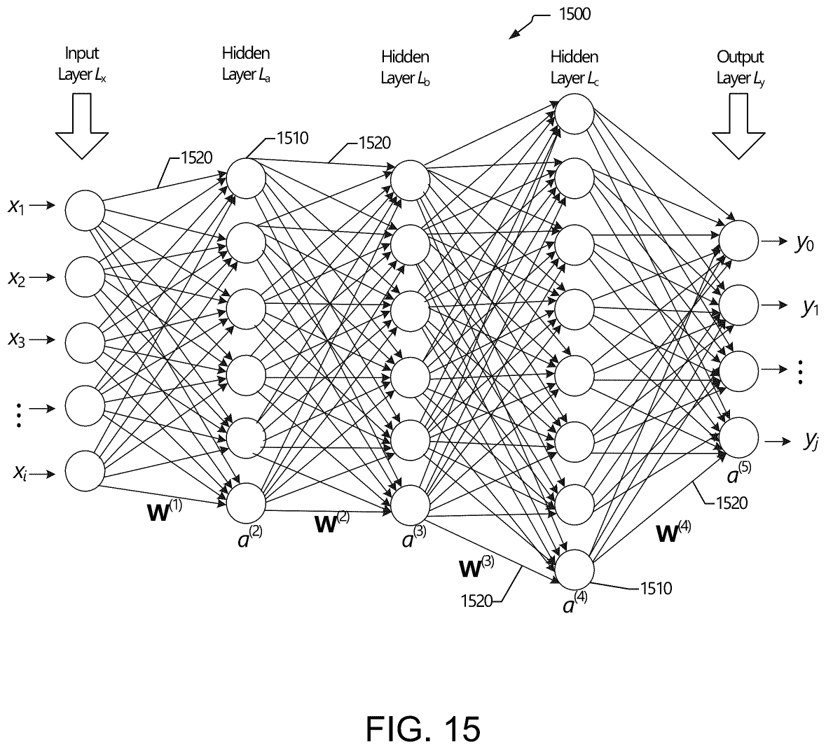

The model repository 1435 is responsible for AI/ML models' (both trained and un-trained) storage and exposure. Various model data can be stored in the model repository 1435. The model data can include, for example, trained/updated model(s), model parameters, hyperparameters, and/or model metadata, such as model performance metrics, hardware platform/configuration data, model execution parameters/conditions, and/or the like. In some examples, the model data can also include inferences made when operating the ML model. Examples of AI/ML models and other ML model aspects are discussed infra w.r.t FIGS. 14 and 15. The model data may be discovered and requested by other MLF components (e.g., the training data selection/filter 1420 and/or the MLTF 1425). In some examples, the MLF 1402 can discover and request model data from the model repository 1435 of the MLF 1404. Additionally or alternatively, the MLF 1404 can discover and/or request model data from the model repository 1435 of the MLF 1402. In some examples, the MLF 1404 may configure models, model parameters, hyperparameters, model execution parameters/conditions, and/or other ML model aspects in the model repository 1435 of the MLF 1402.

The model management (mgmt) function 1440 is responsible for mgmt of the AI/ML model produced by the MLTF 1425. Such mgmt functions may include deployment of a trained model, monitoring ML entity performance, reporting ML entity validation and/or performance data, and/or the like. In model deployment, the model mgmt 1440 may allocate and schedule hardware and/or software resources for inference, based on received trained and tested models. For purposes of the present disclosure, the term “inference” refers to the process of using trained AI/ML model(s) to generate statistical inferences, predictions, decisions, probabilities and/or probability distributions, actions, configurations, policies, data analytics, outcomes, optimizations, and/or the like based on new, unseen data (e.g., “input inference data”). In some examples, the inference process can include feeding input inference data into the ML model (e.g., inference engine 1445), forward passing the input inference data through the ML model's architecture/topology wherein the ML model performs computations on the data using its learned parameters (e.g., weights and biases), and predictions output. In some examples, the inference process can include data transformation before the forward pass, wherein the input inference data is preprocessed or transformed to match the format required by the ML model. In performance monitoring, based on model performance KPIs and/or metrics, the model mgmt 1440 may decide to terminate the running model, start model re-training and/or tuning, select another model, and/or the like. In examples, the model mgmt 1440 of the MLF 1404 may be able to configure model mgmt policies in the MLF 1402, and vice versa.

The inference data selection/filter 1450 is responsible for generating datasets for model inference at the inference 1445, as described infra. For example, inference data may be extracted from the data repository 1415. The inference data selection/filter 1450 may select and/or filter the data based on the deployed AI/ML model. Data may be transformed, augmented, and/or pre-processed in a same or similar manner as the transformation, augmentation, and/or pre-processing of the training data selection/filtering as described w.r.t training data selection filter 1420. The produced inference dataset may be fed into the inference engine 1445.

FIG. 15 illustrates an example neural network, in accordance with one or more embodiments.

The NN 1500 may be suitable for use by one or more of the computing systems (or subsystems) of the various implementations discussed herein, implemented in part by a HW accelerator, and/or the like. The NN 1500 may be deep neural network (DNN) used as an artificial brain of a compute node or network of compute nodes to handle very large and complicated observation spaces. Additionally or alternatively, the NN 1500 can be some other type of topology (or combination of topologies), such as a convolution NN (CNN), deep CNN (DCN), recurrent NN (RNN), Long Short Term Memory (LSTM) network, a Deconvolutional NN (DNN), gated recurrent unit (GRU), deep belief NN, a feed forward NN (FFN), a deep FNN (DFF), deep stacking network, Markov chain, perception NN, Bayesian Network (BN) or Bayesian NN (BNN), Dynamic BN (DBN), Linear Dynamical System (LDS), Switching LDS (SLDS), Optical NNs (ONNs), an NN for reinforcement learning (RL) and/or deep RL (DRL), and/or the like. NNs are usually used for supervised learning, but can be used for unsupervised learning and/or RL.

The NN 1500 may encompass a variety of ML techniques where a collection of connected artificial neurons 1510 that (loosely) model neurons in a biological brain that transmit signals to other neurons/nodes 1510. The neurons 1510 may also be referred to as nodes 1510, processing elements (PEs) 1510, or the like. The connections 1520 (or edges 1520) between the nodes 1510 are (loosely) modeled on synapses of a biological brain and convey the signals between nodes 1510. Note that not all neurons 1510 and edges 1520 are labeled in FIG. 15 for the sake of clarity.

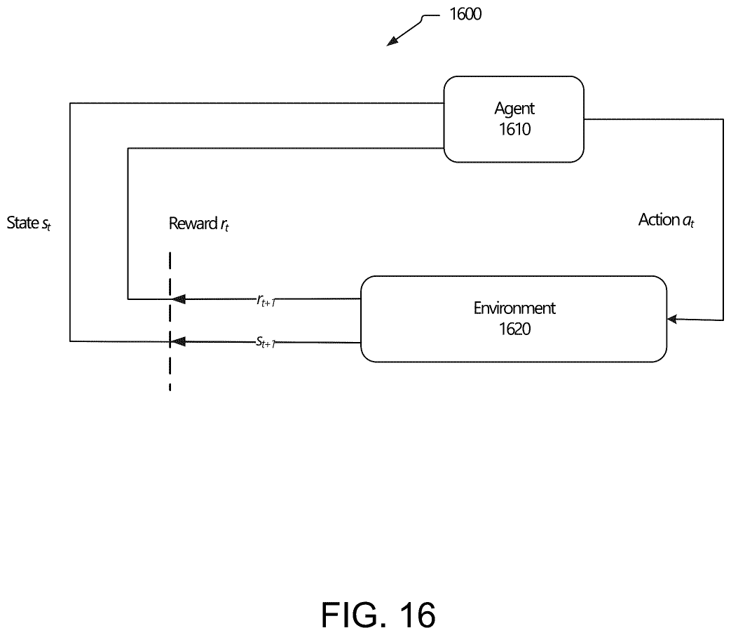

FIG. 16 shows an RL architecture 1600 comprising an agent 1610 and an environment 1620. The agent 1610 (e.g., software agent or AI agent) is the learner and decision maker, and the environment 1620 comprises everything outside the agent 1610 that the agent 1610 interacts with. The environment 1620 is typically stated in the form of a Markov decision process (MDP), which may be described using dynamic programming techniques. An MDP is a discrete-time stochastic control process that provides a mathematical framework for modeling decision making in situations where outcomes are partly random and partly under the control of a decision maker.

The following examples pertain to further embodiments.

Example 1 may include an apparatus of a Service Based Management Architecture (SBMA) Management Service (MnS) Producer, the apparatus comprising processing circuitry coupled to storage for storing information associated with deploying machine learning (ML) models, the processing circuitry configured to: receive an ML model loading request from an MnS Consumer, or identify an ML model loading policy defining an ML model and a target inference function to which the ML model is to be loaded; instantiate an ML model loading process to load the ML model to the target inference function, the ML model loading processing comprising a progress status attribute indicative of a progress of loading the ML model to the target inference function; and create a Managed Object Instance (MOI) of the ML model under an MOI of the target inference function based on completion of the loading of the ML model to the target inference function.

Example 2 may include the apparatus of example 1 and/or any other example herein, wherein the ML model loading policy further defines a second target inference function to which the ML model is to be loaded.

Example 3 may include the apparatus of example 2 and/or any other example herein, wherein the processing circuitry is further configured to create a second MOI of the ML model under an MOI of the second target inference function based on completion of the loading of the ML model to the second target inference function.

Example 4 may include the apparatus of example 1 and/or any other example herein, wherein to instantiate the ML model loading process is in response to the received ML model loading request from the MnS Consumer, and wherein the received ML model loading request defines the ML model to be loaded.

Example 5 may include the apparatus of example 1 and/or any other example herein, wherein to instantiate the ML model loading process occurs based on the ML model loading policy without the ML model loading request from the MnS Consumer

Example 6 may include the apparatus of example 1 and/or any other example herein, wherein the ML model loading policy further defines a condition for training the ML model.

Example 7 may include a non-transitory computer-readable medium storing computer-executable instructions for deploying machine learning (ML) models, which when executed by one or more processors of a Service Based Management Architecture (SBMA) Management Service (MnS) Producer result in performing operations comprising: receiving an ML model loading request from an MnS consumer, or identifying an ML model loading policy defining an ML model and a target inference function to which the ML model is to be loaded; instantiating an ML model loading process to load the ML model to the target inference function, the ML model loading processing comprising a progress status attribute indicative of a progress of loading the ML model to the target inference function; and creating a Managed Object Instance (MOI) of the ML model under an MOI of the target inference function based on completion of the loading of the ML model to the target inference function.

Example 8 may include the non-transitory computer-readable medium of example 7 and/or any other example herein, wherein the ML model loading policy further defines a second target inference function to which the ML model is to be loaded.

Example 9 may include the non-transitory computer-readable medium of example 8 and/or any other example herein, wherein the operations further comprise creating a second MOI of the ML model under an MOI of the second target inference function based on completion of the loading of the ML model to the second target inference function.

Example 10 may include the non-transitory computer-readable medium of example 7 and/or any other example herein, wherein instantiating the ML model loading process is in response to the received ML model loading request from the MnS Consumer, and wherein the received ML model loading request defines the ML model to be loaded.

Example 11 may include the non-transitory computer-readable medium of example 7 and/or any other example herein, wherein to instantiate the ML model loading process occurs based on the ML model loading policy without the ML model loading request from the MnS Consumer.

Example 12 may include the non-transitory computer-readable medium of example 7 and/or any other example herein, wherein the ML model loading policy further defines a condition for training the ML model.

Example 13 may include a method for deploying machine learning (ML) models, the method comprising: receiving, by processing circuitry of a Service Based Management Architecture (SBMA) Management Service (MnS) Producer, an ML model loading request from an MnS consumer, or identifying, by the processing circuitry, an ML model loading policy defining an ML model and a target inference function to which the ML model is to be loaded; instantiating, by the processing circuitry, an ML model loading process to load the ML model to the target inference function, the ML model loading processing comprising a progress status attribute indicative of a progress of loading the ML model to the target inference function; and creating, by the processing circuitry, a Managed Object Instance (MOI) of the ML model under an MOI of the target inference function based on completion of the loading of the ML model to the target inference function.

Example 14 may include the method of example 13 and/or any other example herein, wherein the ML model loading policy further defines a second target inference function to which the ML model is to be loaded.

Example 15 may include the method of example 14 and/or any other example herein, further comprising creating a second MOI of the ML model under an MOI of the second target inference function based on completion of the loading of the ML model to the second target inference function.

Example 16 may include the method of example 13 and/or any other example herein, wherein instantiating the ML model loading process is in response to the received ML model loading request from the MnS Consumer, and wherein the received ML model loading request defines the ML model to be loaded.

Example 17 may include the method of example 13 and/or any other example herein, wherein to instantiate the ML model loading process occurs based on the ML model loading policy without the ML model loading request from the MnS Consumer.

Example 18 may include the method of example 13 and/or any other example herein, wherein the ML model loading policy further defines a condition for training the ML model.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Various embodiments are described below.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

Unless used differently herein, terms, definitions, and abbreviations may be consistent with terms, definitions, and abbreviations defined in 3GPP TR 21.905 v16.0.0 (2019 June) and/or any other 3GPP standard. For the purposes of the present document, the following abbreviations (shown in Table 14) may apply to the examples and embodiments discussed herein.

TABLE 14
Abbreviations:

| | | | | | |
|---|---|---|---|---|---|
| 3GPP | Third Generation | IBE | In-Band Emission | PUSCH | Physical Uplink Shared |
| | Partnership Project | | | | Channel |
| 4G | Fourth Generation | IEEE | Institute of Electrical | QAM | Quadrature Amplitude |
| | | | and Electronics | | Modulation |
| | | | Engineers | | |
| 5G | Fifth Generation | IEI | Information Element | QCI | QoS class of identifier |
| | | | Identifier | | |
| 5GC | 5G Core network | IEIDL | Information Element | QCL | Quasi co-location |
| | | | Identifier Data Length | | |
| AC | Application Client | IETF | Internet Engineering | QFI | QoS Flow ID, QoS Flow |
| | | | Task Force | | Identifier |
| ACK | Acknowledgement | IF | Infrastructure | QoS | Quality of Service |
| ACID | Application Client | IM | Interference | QPSK | Quadrature (Quaternary) |
| | Identification | | Measurement, | | Phase Shift Keying |
| | | | Intermodulation, IP | | |
| | | | Multimedia | | |
| AF | Application Function | IMC | IMS Credentials | QZSS | Quasi-Zenith Satellite |
| | | | | | System |
| AM | Acknowledged Mode | IMEI | International Mobile | RA-RNTI | Random Access RNTI |
| | | | Equipment Identity | | |
| AMBR | Aggregate Maximum Bit | IMGI | International mobile | RAB | Radio Access Bearer, |
| | Rate | | group identity | | Random Access Burst |
| AMF | Access and Mobility | IMPI | IP Multimedia Private | RACH | Random Access Channel |
| | Management Function | | Identity | | |
| AN | Access Network | IMPU | IP Multimedia PUblic | RADIUS | Remote Authentication |
| | | | identity | | Dial In User Service |
| ANR | Automatic Neighbour | IMS | IP Multimedia | RAN | Radio Access Network |
| | Relation | | Subsystem | | |
| AP | Application Protocol, | IMSI | International Mobile | RAND | RANDom number (used |
| | Antenna Port, Access Point | | Subscriber Identity | | for authentication) |
| API | Application Programming | IoT | Internet of Things | RAR | Random Access Response |
| | Interface | | | | |
| APN | Access Point Name | IP | Internet Protocol | RAT | Radio Access |
| | | | | | Technology |
| ARP | Allocation and Retention | Ipsec | IP Security, Internet | RAU | Routing Area Update |
| | Priority | | Protocol Security | | |
| ARQ | Automatic Repeat Request | IP-CAN | IP-Connectivity Access | RB | Resource block, Radio |
| | | | Network | | Bearer |
| AS | Access Stratum | IP-M | IP Multicast | RBG | Resource block group |
| ASP | Application Service | IPv4 | Internet Protocol | REG | Resource Element |
| | Provider | | Version 4 | | Group |
| ASN.1 | Abstract Syntax Notation | IPv6 | Internet Protocol | Rel | Release |
| | One | | Version 6 | | |
| AUSF | Authentication Server | IR | Infrared | REQ | REQuest |
| | Function | | | | |
| AWGN | Additive White Gaussian | IS | In Sync | RF | Radio Frequency |
| | Noise | | | | |
| BAP | Backhaul Adaptation | IRP | Integration Reference | RI | Rank Indicator |
| | Protocol | | Point | | |
| BCH | Broadcast Channel | ISDN | Integrated Services | RIV | Resource indicator value |
| | | | Digital Network | | |
| BER | Bit Error Ratio | ISIM | IM Services Identity | RL | Radio Link |
| | | | Module | | |
| BFD | Beam Failure Detection | ISO | International | RLC | Radio Link Control, |
| | | | Organisation for | | Radio Link Control |
| | | | Standardisation | | layer |
| BLER | Block Error Rate | ISP | Internet Service | RLC AM | RLC Acknowledged |
| | | | Provider | | Mode |
| BPSK | Binary Phase Shift Keying | IWF | Interworking-Function | RLC UM | RLC Unacknowledged |
| | | | | | Mode |
| BRAS | Broadband Remote Access | I-WLAN | Interworking WLAN | RLF | Radio Link Failure |
| | Server | | | | |
| BSS | Business Support System | | Constraint length of the | RLM | Radio Link Monitoring |
| | | | convolutional code, USIM | | |
| | | | Individual key | | |
| BS | Base Station | kB | Kilobyte (1000 bytes) | RLM-RS | Reference Signal for |
| | | | | | RLM |
| BSR | Buffer Status Report | kbps | kilo-bits per second | RM | Registration |
| | | | | | Management |
| BW | Bandwidth | Kc | Ciphering key | RMC | Reference Measurement |
| | | | | | Channel |
| BWP | Bandwidth Part | Ki | Individual subscriber | RMSI | Remaining MSI, |
| | | | authentication key | | Remaining Minimum |
| | | | | | System Information |
| C-RNTI | Cell Radio Network | KPI | Key Performance | RN | Relay Node |
| | Temporary Identity | | Indicator | | |
| CA | Carrier Aggregation, | KQI | Key Quality Indicator | RNC | Radio Network |
| | Certification Authority | | | | Controller |
| CAPEX | CAPital EXpenditure | KSI | Key Set Identifier | RNL | Radio Network Layer |
| CBRA | Contention Based Random | ksps | kilo-symbols per second | RNTI | Radio Network |
| | Access | | | | Temporary Identifier |
| CC | Component Carrier, | KVM | Kernel Virtual Machine | ROHC | RObust Header |
| | Country Code, | | | | Compression |
| | Cryptographic Checksum | | | | |
| CCA | Clear Channel Assessment | L1 | Layer 1 (physical layer) | RRC | Radio Resource Control, |
| | | | | | Radio Resource Control |
| | | | | | layer |
| CCE | Control Channel Element | L1-RSRP | Layer 1 reference signal | RRM | Radio Resource |
| | | | received power | | Management |
| CCCH | Common Control Channel | L2 | Layer 2 (data link layer) | RS | Reference Signal |
| CE | Coverage Enhancement | L3 | Layer 3 (network layer) | RSRP | Reference Signal |
| | | | | | Received Power |
| CDM | Content Delivery Network | LAA | Licensed Assisted | RSRQ | Reference Signal |
| | | | Access | | Received Quality |
| CDMA | Code-Division Multiple | LAN | Local Area Network | RSSI | Received Signal |
| | Access | | | | Strength Indicator |
| CFRA | Contention Free Random | LADN | Local Area Data | RSU | Road Side Unit |
| | Access | | Network | | |
| CG | Cell Group | LBT | Listen Before Talk | RSTD | Reference Signal Time |
| | | | | | difference |
| CGF | Charging Gateway Function | LCM | LifeCycle Management | RTP | Real Time Protocol |
| CHF | Charging Function | LCR | Low Chip Rate | RTS | Ready-To-Send |
| CI | Cell Identity | LCS | Location Services | RTT | Round Trip Time |
| CID | Cell-ID (e.g., positioning | LCID | Logical Channel ID | Rx | Reception, Receiving, |
| | method) | | | | Receiver |
| CIM | Common Information | LI | Layer Indicator | S1AP | S1 Application Protocol |
| | Model | | | | |
| CIR | Carrier to Interference | LLC | Logical Link Control, | S1-MME | S1 for the control plane |
| | Ratio | | Low Layer | | |
| | | | Compatibility | | |
| CK | Cipher Key | LPLMN | Local PLMN | S1-U | S1 for the user plane |
| CM | Connection Management, | LPP | LTE Positioning | S-GW | Serving Gateway |
| | Conditional Mandatory | | Protocol | | |
| CMAS | Commercial Mobile Alert | LSB | Least Significant Bit | S-RNTI | SRNC Radio Network |
| | Service | | | | Temporary Identity |
| CMD | Command | LTE | Long Term Evolution | S-TMSI | SAE Temporary Mobile |
| | | | | | Station Identifier |
| CMS | Cloud Management System | LWA | LTE-WLAN | SA | Standalone operation |
| | | | aggregation | | mode |
| CO | Conditional Optional | LWIP | LTE/WLAN Radio | SAE | System Architecture |
| | | | Level Integration with | | Evolution |
| | | | IPsec Tunnel | | |
| CoMP | Coordinated Multi-Point | LTE | Long Term Evolution | SAP | Service Access Point |
| CORESET | Control Resource Set | M2M | Machine-to-Machine | SAPD | Service Access Point |
| | | | | | Descriptor |
| COTS | Commercial Off-The-Shelf | MAC | Medium Access Control | SAPI | Service Access Point |
| | | | (protocol layering | | Identifier |
| | | | context) | | |
| CP | Control Plane, Cyclic | MAC | Message authentication | SCC | Secondary Component |
| | Prefix, Connection Point | | code | | Carrier, Secondary CC |
| | | | (security/encryption | | |
| | | | context) | | |
| CPD | Connection Point | MAC-A | MAC used for | SCell | Secondary Cell |
| | Descriptor | | authentication and key | | |
| | | | agreement (TSG T WG3 | | |
| | | | context) | | |
| CPE | Customer Premise | MAC-I | MAC used for data | SCEF | Service Capability |
| | Equipment | | integrity of signalling | | Exposure Function |
| | | | messages (TSG T WG3 | | |
| | | | context) | | |
| CPICH | Common Pilot Channel | MANO | Management and | SC-FDMA | Single Carrier |
| | | | Orchestration | | Frequency Division |
| | | | | | Multiple Access |
| CQI | Channel Quality Indicator | MBMS | Multimedia Broadcast | SCG | Secondary Cell Group |
| | | | and Multicast Service | | |
| CPU | CSI processing unit, Central | MBSFN | Multimedia Broadcast | SCM | Security Context |
| | Processing Unit | | multicast service Single | | Management |
| | | | Frequency Network | | |
| C/R | Command/Response field | MCC | Mobile Country Code | SCS | Subcarrier Spacing |
| | bit | | | | |
| CRAN | Cloud Radio Access | MCG | Master Cell Group | SCTP | Stream Control |
| | Network, Cloud RAN | | | | Transmission Protocol |
| CRB | Common Resource Block | MCOT | Maximum Channel | SDAP | Service Data Adaptation |
| | | | Occupancy Time | | Protocol, Service Data |
| | | | | | Adaptation Protocol |
| | | | | | layer |
| CRC | Cyclic Redundancy Check | MCS | Modulation and coding | SDL | Supplementary |
| | | | scheme | | Downlink |
| CRI | Channel-State Information | MDAF | Management Data | SDNF | Structured Data Storage |
| | Resource Indicator, CSI-RS | | Analytics Function | | Network Function |
| | Resource Indicator | | | | |
| C-RNTI | Cell RNTI | MDAS | Management Data | SDP | Session Description |
| | | | Analytics Service | | Protocol |
| CS | Circuit Switched | MDT | Minimization of Drive | SDSF | Structured Data Storage |
| | | | Tests | | Function |
| CSAR | Cloud Service Archive | ME | Mobile Equipment | SDU | Service Data Unit |
| CSI | Channel-State Information | MeNB | master eNB | SEAF | Security Anchor |
| | | | | | Function |
| CSI-IM | CSI Interference | MER | Message Error Ratio | SeNB | secondary eNB |
| | Measurement | | | | |
| CSI-RS | CSI Reference Signal | MGL | Measurement Gap | SEPP | Security Edge Protection |
| | | | Length | | Proxy |
| CSI-RSRP | CSI reference signal | MGRP | Measurement Gap | SFI | Slot format indication |
| | received power | | Repetition Period | | |
| CSI-RSRQ | CSI reference signal | MIB | Master Information | SFTD | Space-Frequency Time |
| | received quality | | Block, Management | | Diversity, SFN and |
| | | | Information Base | | frame timing difference |
| CSI-SINR | CSI signal-to-noise and | MIMO | Multiple Input Multiple | SFN | System Frame Number |
| | interference ratio | | Output | | |
| CSMA | Carrier Sense Multiple | MLC | Mobile Location Centre | SgNB | Secondary gNB |
| | Access | | | | |
| CSMA/CA | CSMA with collision | MM | Mobility Management | SGSN | Serving GPRS Support |
| | avoidance | | | | Node |
| CSS | Common Search Space, | MME | Mobility Management | S-GW | Serving Gateway |
| | Cell-specific Search Space | | Entity | | |
| CTF | Charging Trigger Function | MN | Master Node | SI | System Information |
| CTS | Clear-to-Send | MNO | Mobile Network | SI-RNTI | System Information |
| | | | Operator | | RNTI |
| CW | Codeword | MO | Measurement Object, | SIB | System Information |
| | | | Mobile Originated | | Block |
| CWS | Contention Window Size | MPBCH | MTC Physical | SIM | Subscriber Identity |
| | | | Broadcast CHannel | | Module |
| D2D | Device-to-Device | MPDCCH | MTC Physical | SIP | Session Initiated |
| | | | Downlink Control | | Protocol |
| | | | CHannel | | |
| DC | Dual Connectivity, Direct | MPDSCH | MTC Physical | SiP | System in Package |
| | Current | | Downlink Shared | | |
| | | | CHannel | | |
| DCI | Downlink Control | MPRACH | MTC Physical Random | SL | Sidelink |
| | Information | | Access CHannel | | |
| DF | Deployment Flavour | MPUSCH | MTC Physical Uplink | SLA | Service Level |
| | | | Shared Channel | | Agreement |
| DL | Downlink | MPLS | MultiProtocol Label | SM | Session Management |
| | | | Switching | | |
| DMTF | Distributed Management | MS | Mobile Station | SMF | Session Management |
| | Task Force | | | | Function |
| DPDK | Data Plane Development | MSB | Most Significant Bit | SMS | Short Message Service |
| | Kit | | | | |
| DM-RS, DMRS | Demodulation | MSC | Mobile Switching | SMSF | SMS Function |
| | Reference Signal | | Centre | | |
| DN | Data network | MSI | Minimum System | SMTC | SSB-based |
| | | | Information, MCH | | Measurement Timing |
| | | | Scheduling Information | | Configuration |
| DNN | Data Network Name | MSID | Mobile Station Identifier | SN | Secondary Node, |
| | | | | | Sequence Number |
| DNAI | Data Network Access | MSIN | Mobile Station | SoC | System on Chip |
| | Identifier | | Identification Number | | |
| DRB | Data Radio Bearer | MSISDN | Mobile Subscriber | SON | Self-Organizing |
| | | | ISDN Number | | Network |
| DRS | Discovery Reference Signal | MT | Mobile Terminated, | SpCell | Special Cell |
| | | | Mobile Termination | | |
| DRX | Discontinuous Reception | MTC | Machine-Type | SP-CSI-RNTI | Semi-Persistent CSI |
| | | | Communications | | RNTI |
| DSL | Domain Specific Language. | mMTC | massive MTC, massive | SPS | Semi-Persistent |
| | Digital Subscriber Line | | Machine-Type | | Scheduling |
| | | | Communications | | |
| DSLAM | DSL Access Multiplexer | MU-MIMO | Multi User MIMO | SQN | Sequence number |
| DwPTS | Downlink Pilot Time Slot | MWUS | MTC wake-up signal, | SR | Scheduling Request |
| | | MTC WUS | | | |
| E-LAN | Ethernet Local Area | NACK | Negative | SRB | Signalling Radio Bearer |
| | Network | | Acknowledgement | | |
| E2E | End-to-End | NAI | Network Access | SRS | Sounding Reference |
| | | | Identifier | | Signal |
| ECCA | extended clear channel | NAS | Non-Access Stratum, | SS | Synchronization Signal |
| | assessment, extended CCA | | Non-Access Stratum | | |
| | | | layer | | |
| ECCE | Enhanced Control Channel | NCT | Network Connectivity | SSB | Synchronization Signal |
| | Element, Enhanced CCE | | Topology | | Block |
| ED | Energy Detection | NC-JT | Non-Coherent Joint | SSID | Service Set Identifier |
| | | | Transmission | | |
| EDGE | Enhanced Datarates for | NEC | Network Capability | SS/PBCH | Block |
| | GSM Evolution (GSM | | Exposure | | |
| | Evolution) | | | | |
| EAS | Edge Application Server | NE-DC | NR-E-UTRA Dual | SSBRI | SS/PBCH Block |
| | | | Connectivity | | Resource Indicator, |
| | | | | | Synchronization Signal |
| | | | | | Block Resource |
| | | | | | Indicator |
| EASID | Edge Application Server | NEF | Network Exposure | SSC | Session and Service |
| | Identification | | Function | | Continuity |
| ECS | Edge Configuration Server | NF | Network Function | SS-RSRP | Synchronization Signal |
| | | | | | based Reference Signal |
| | | | | | Received Power |
| ECSP | Edge Computing Service | NFP | Network Forwarding | SS-RSRQ | Synchronization Signal |
| | Provider | | Path | | based Reference Signal |
| | | | | | Received Quality |
| EDN | Edge Data Network | NFPD | Network Forwarding | SS-SINR | Synchronization Signal |
| | | | Path Descriptor | | based Signal to Noise |
| | | | | | and Interference Ratio |
| EEC | Edge Enabler Client | NFV | Network Functions | SSS | Secondary |
| | | | Virtualization | | Synchronization Signal |
| EECID | Edge Enabler Client | NFVI | NFV Infrastructure | SSSG | Search Space Set Group |
| | Identification | | | | |
| EES | Edge Enabler Server | NFVO | NFV Orchestrator | SSSIF | Search Space Set |
| | | | | | Indicator |
| EESID | Edge Enabler Server | NG | Next Generation, Next | SST | Slice/Service Types |
| | Identification | | Gen | | |
| EHE | Edge Hosting Environment | NGEN-DC | NG-RAN E-UTRA- | SU-MIMO | Single User MIMO |
| | | | NR Dual Connectivity | | |
| EGMF | Exposure Governance | NM | Network Manager | SUL | Supplementary Uplink |
| | tableManagement Function | | | | |
| EGPRS | Enhanced GPRS | NMS | Network Management | TA | Timing Advance, |
| | | | System | | Tracking Area |
| EIR | Equipment Identity Register | N-POP | Network Point of | TAC | Tracking Area Code |
| | | | Presence | | |
| eLAA | enhanced Licensed Assisted | NMIB, N-MIB | Narrowband MIB | TAG | Timing Advance Group |
| | Access, enhanced LAA | | | | |
| EM | Element Manager | NPBCH | Narrowband Physical | TAI | Tracking Area Identity |
| | | | Broadcast CHannel | | |
| eMBB | Enhanced Mobile | NPDCCH | Narrowband Physical | TAU | Tracking Area Update |
| | Broadband | | Downlink Control | | |
| | | | CHannel | | |
| EMS | Element Management | NPDSCH | Narrowband Physical | TB | Transport Block |
| | System | | Downlink Shared | | |
| | | | CHannel | | |
| eNB | evolved NodeB, E-UTRAN | NPRACH | Narrowband Physical | TBS | Transport Block Size |
| | Node B | | Random Access | | |
| | | | CHannel | | |
| EN-DC | E-UTRA-NR Dual | NPUSCH | Narrowband Physical | TBD | To Be Defined |
| | Connectivity | | Uplink Shared CHannel | | |
| EPC | Evolved Packet Core | NPSS | Narrowband Primary | TCI | Transmission |
| | | | Synchronization Signal | | Configuration Indicator |
| EPDCCH | enhanced PDCCH, | NSSS | Narrowband Secondary | TCP | Transmission |
| | enhanced Physical | | Synchronization Signal | | Communication |
| | Downlink Control Cannel | | | | Protocol |
| EPRE | Energy per resource | NR | New Radio, Neighbour | TDD | Time Division Duplex |
| | element | | Relation | | |
| EPS | Evolved Packet System | NRF | NF Repository Function | TDM | Time Division |
| | | | | | Multiplexing |
| EREG | enhanced REG, enhanced | NRS | Narrowband Reference | TDMA | Time Division Multiple |
| | resource element groups | | Signal | | Access |
| ETSI | European | NS | Network Service | TE | Terminal Equipment |
| | Telecommunications | | | | |
| | Standards Institute | | | | |
| ETWS | Earthquake and Tsunami | NSA | Non-Standalone | TEID | Tunnel End Point |
| | Warning System | | operation mode | | Identifier |
| eUICC | embedded UICC, | NSD | Network Service | TFT | Traffic Flow Template |
| | embedded Universal | | Descriptor | | |
| | Integrated Circuit Card | | | | |
| E-UTRA | Evolved UTRA | NSR | Network Service Record | TMSI | Temporary Mobile |
| | | | | | Subscriber Identity |
| E-UTRAN | Evolved UTRAN | NSSAI | Network Slice Selection | TNL | Transport Network |
| | | | Assistance Information | | Layer |
| EV2X | Enhanced V2X | S-NNSAI | Single-NSSAI | TPC | Transmit Power Control |
| F1AP | F1 Application Protocol | NSSF | Network Slice Selection | TPMI | Transmitted Precoding |
| | | | Function | | Matrix Indicator |
| F1-C | F1 Control plane interface | NW | Network | TR | Technical Report |
| F1-U | F1 User plane interface | NWUS | Narrowband wake-up | TRP, TRxP | Transmission |
| | | | signal, Narrowband | | Reception Point |
| | | | WUS | | |
| FACCH | Fast Associated Control | NZP | Non-Zero Power | TRS | Tracking Reference |
| | CHannel | | | | Signal |
| FACCH/F | Fast Associated Control | O&M | Operation and | TRx | Transceiver |
| | Channel/Full rate | | Maintenance | | |
| FACCH/H | Fast Associated Control | ODU2 | Optical channel Data | TS | Technical |
| | Channel/Half rate | | Unit - type 2 | | Specifications, |
| | | | | | Technical Standard |
| FACH | Forward Access Channel | OFDM | Orthogonal Frequency | TTI | Transmission Time |
| | | | Division Multiplexing | | Interval |
| FAUSCH | Fast Uplink Signalling | OFDMA | Orthogonal Frequency | Tx | Transmission, |
| | Channel | | Division Multiple | | Transmitting, |
| | | | Access | | Transmitter |
| FB | Functional Block | OOB | Out-of-band | U-RNTI | UTRAN Radio Network |
| | | | | | Temporary Identity |
| FBI | Feedback Information | OOS | Out of Sync | UART | Universal Asynchronous |
| | | | | | Receiver and |
| | | | | | Transmitter |
| FCC | Federal Communications | OPEX | OPerating EXpense | UCI | Uplink Control |
| | Commission | | | | Information |
| FCCH | Frequency Correction | OSI | Other System | UE | User Equipment |
| | CHannel | | Information | | |
| FDD | Frequency Division Duplex | OSS | Operations Support | UDM | Unified Data |
| | | | System | | Management |
| FDM | Frequency Division | OTA | over-the-air | UDP | User Datagram Protocol |
| | Multiplex | | | | |
| FDMA | Frequency Division | PAPR | Peak-to-Average Power | UDSF | Unstructured Data |
| | Multiple Access | | Ratio | | Storage Network |
| | | | | | Function |
| FE | Front End | PAR | Peak to Average Ratio | UICC | Universal Integrated |
| | | | | | Circuit Card |
| FEC | Forward Error Correction | PBCH | Physical Broadcast | UL | Uplink |
| | | | Channel | | |
| FFS | For Further Study | PC | Power Control, Personal | UM | Unacknowledged Mode |
| | | | Computer | | |
| FFT | Fast Fourier Transformation | PCC | Primary Component | UML | Unified Modelling |
| | | | Carrier, Primary CC | | Language |
| feLAA | further enhanced Licensed | PCell | Primary Cell | UMTS | Universal Mobile |
| | Assisted Access, further | | | | Telecommunications |
| | enhanced LAA | | | | System |
| FN | Frame Number | PCI | Physical Cell ID, | UP | User Plane |
| | | | Physical Cell Identity | | |
| FPGA | Field-Programmable Gate | PCEF | Policy and Charging | UPF | User Plane Function |
| | Array | | Enforcement Function | | |
| FR | Frequency Range | PCF | Policy Control Function | URI | Uniform Resource |
| | | | | | Identifier |
| FQDN | Fully Qualified Domain | PCRF | Policy Control and Charging | URL | Uniform Resource |
| | Name | | Rules Function | | Locator |
| G-RNTI | GERAN Radio Network | PDCP | Packet Data | URLLC | Ultra-Reliable and Low |
| | Temporary Identity | | Convergence Protocol, | | Latency |
| | | | Packet Data | | |
| | | | Convergence Protocol | | |
| | | | layer | | |
| GERAN | GSM EDGE RAN, GSM | PDCCH | Physical Downlink | USB | Universal Serial Bus |
| | EDGE Radio Access | | Control Channel | | |
| | Network | | | | |
| GGSN | Gateway GPRS Support | PDCP | Packet Data | USIM | Universal Subscriber |
| | Node | | Convergence Protocol | | Identity Module |
| GLONASS | GLObal’naya | PDN | Packet Data Network, | USS | UE-specific search space |
| | NAvigatsionnaya | | Public Data Network | | |
| | Sputnikovaya Sistema | | | | |
| | (Engl.: Global Navigation | | | | |
| | Satellite System) | | | | |
| gNB | Next Generation NodeB | PDSCH | Physical Downlink | UTRA | UMTS Terrestrial Radio |
| | | | Shared Channel | | Access |
| gNB-CU | gNB-centralized unit, Next | PDU | Protocol Data Unit | UTRAN | Universal Terrestrial |
| | Generation NodeB | | | | Radio Access Network |
| | centralized unit | | | | |
| gNB-DU | gNB-distributed unit, Next | PEI | Permanent Equipment | UwPTS | Uplink Pilot Time Slot |
| | Generation NodeB | | Identifiers | | |
| | distributed unit | | | | |
| GNSS | Global Navigation Satellite | PFD | Packet Flow Description | V2I | Vehicle-to-Infrastruction |
| | System | | | | |
| GPRS | General Packet Radio | P-GW | PDN Gateway | V2P | Vehicle-to-Pedestrian |
| | Service | | | | |
| GPSI | Generic Public Subscription | PHICH | Physical hybrid-ARQ | V2V | Vehicle-to-Vehicle |
| | Identifier | | indicator channel | | |
| GSM | Global System for Mobile | PHY | Physical layer | V2X | Vehicle-to-everything |
| | Communications, Groupe | | | | |
| | Spécial Mobile | | | | |
| GTP | GPRS Tunneling Protocol | PLMN | Public Land Mobile | VIM | Virtualized |
| | | | Network | | Infrastructure Manager |
| GTP-U | GPRS Tunnelling Protocol | PIN | Personal Identification | VL | Virtual Link, |
| | for User Plane | | Number | | |
| GTS | Go To Sleep Signal (related | PM | Performance | VLAN | Virtual LAN, Virtual |
| | to WUS) | | Measurement | | Local Area Network |
| GUMMEI | Globally Unique MME | PMI | Precoding Matrix | VM | Virtual Machine |
| | Identifier | | Indicator | | |
| GUTI | Globally Unique | PNF | Physical Network | VNF | Virtualized Network |
| | Temporary UE Identity | | Function | | Function |
| HARQ | Hybrid ARQ, Hybrid | PNFD | Physical Network | VNFFG | VNF Forwarding Graph |
| | Automatic Repeat Request | | Function Descriptor | | |
| HANDO | Handover | PNFR | Physical Network | VNFFGD | VNF Forwarding Graph |
| | | | Function Record | | Descriptor |
| HFN | HyperFrame Number | POC | PTT over Cellular | VNFM | VNF Manager |
| HHO | Hard Handover | PP, PTP | Point-to-Point | VoIP | Voice-over-IP, Voice- |
| | | | | | over-Internet Protocol |
| HLR | Home Location Register | PPP | Point-to-Point Protocol | VPLMN | Visited Public Land |
| | | | | | Mobile Network |
| HN | Home Network | PRACH | Physical RACH | VPN | Virtual Private Network |
| HO | Handover | PRB | Physical resource block | VRB | Virtual Resource Block |
| HPLMN | Home Public Land Mobile | PRG | Physical resource block | WiMAX | Worldwide |
| | Network | | group | | Interoperability for |
| | | | | | Microwave Access |
| HSDPA | High Speed Downlink | ProSe | Proximity Services, | WLAN | Wireless Local Area |
| | Packet Access | | Proximity-Based | | Network |
| | | | Service | | |
| HSN | Hopping Sequence Number | PRS | Positioning Reference | WMAN | Wireless Metropolitan |
| | | | Signal | | Area Network |
| HSPA | High Speed Packet Access | PRR | Packet Reception Radio | WPAN | Wireless Personal Area |
| | | | | | Network |
| HSS | Home Subscriber Server | PS | Packet Services | X2-C | X2-Control plane |
| HSUPA | High Speed Uplink Packet | PSBCH | Physical Sidelink | X2-U | X2-User plane |
| | Access | | Broadcast Channel | | |
| HTTP | Hyper Text Transfer | PSDCH | Physical Sidelink | XML | eXtensible Markup |
| | Protocol | | Downlink Channel | | Language |
| HTTPS | Hyper Text Transfer | PSCCH | Physical Sidelink | XRES | EXpected user |
| | Protocol Secure (https is | | Control Channel | | RESponse |
| | http/1.1 over SSL, i.e. port | | | | |
| | 443) | | | | |
| I-Block | Information Block | PSSCH | Physical Sidelink | XOR | eXclusive OR |
| | | | Shared Channel | | |
| ICCID | Integrated Circuit Card | PSCell | Primary SCell | ZC | Zadoff-Chu |
| | Identification | | | | |
| IAB | Integrated Access and | PSS | Primary | ZP | Zero Po |
| | Backhaul | | Synchronization Signal | | |
| ICIC | Inter-Cell Interference | PSTN | Public Switched | | |
| | Coordination | | Telephone Network | | |
| ID | Identity, identifier | PT-RS | Phase-tracking reference | | |
| | | | signal | | |
| IDFT | Inverse Discrete Fourier | PTT | Push-to-Talk | | |
| | Transform | | | | |
| IE | Information element | PUCCH | Physical Uplink Control | | |
| | | | Channel | | |

What is claimed is:

1. An apparatus of a Service Based Management Architecture (SBMA) Management Service (MnS) Producer, the apparatus comprising processing circuitry coupled to storage for storing information associated with deploying machine learning (ML) models, the processing circuitry configured to:
identify an ML model loading policy defining an ML model and a target inference function to which the ML model is to be loaded;
instantiate an ML model loading process to load the ML model to the target inference function, the ML model loading process comprising a progress status attribute indicative of a progress of loading the ML model to the target inference function; and
create a Managed Object Instance (MOI) of the ML model under an MOI of the target inference function based on completion of the loading of the ML model to the target inference function.

2. The apparatus of claim 1, wherein the ML model loading policy further defines a second target inference function to which the ML model is to be loaded.

3. The apparatus of claim 2, wherein the processing circuitry is further configured to create a second MOI of the ML model under an MOI of the second target inference function based on completion of the loading of the ML model to the second target inference function.

4. The apparatus of claim 1, wherein to instantiate the ML model loading process is in response a received ML model loading request from an MnS Consumer, and wherein the ML model loading request defines the ML model to be loaded.

5. The apparatus of claim 1, wherein to instantiate the ML model loading process occurs based on the ML model loading policy without an ML model loading request from an MnS Consumer.

6. The apparatus of claim 1, wherein the ML model loading policy further defines a condition for training the ML model.

7. A non-transitory computer-readable medium storing computer-executable instructions for deploying machine learning (ML) models, which when executed by one or more processors of a Service Based Management Architecture (SBMA) Management Service (MnS) Producer result in performing operations comprising:
identifying an ML model loading policy defining an ML model and a target inference function to which the ML model is to be loaded;
instantiating an ML model loading process to load the ML model to the target inference function, the ML model loading process comprising a progress status attribute indicative of a progress of loading the ML model to the target inference function; and
creating a Managed Object Instance (MOI) of the ML model under an MOI of the target inference function based on completion of the loading of the ML model to the target inference function.

8. The non-transitory computer-readable medium of claim 7, wherein the ML model loading policy further defines a second target inference function to which the ML model is to be loaded.

9. The non-transitory computer-readable medium of claim 8, wherein the operations further comprise creating a second MOI of the ML model under an MOI of the second target inference function based on completion of the loading of the ML model to the second target inference function.

10. The non-transitory computer-readable medium of claim 7, wherein instantiating the ML model loading process is in response to a received ML model loading request from an MnS Consumer, and wherein the ML model loading request defines the ML model to be loaded.

11. The non-transitory computer-readable medium of claim 7, wherein to instantiate the ML model loading process occurs based on the ML model loading policy without an ML model loading request from an MnS Consumer.

12. The non-transitory computer-readable medium of claim 7, wherein the ML model loading policy further defines a condition for training the ML model.

13. A network node of a 5^{th} Generation wireless network, the network comprising memory coupled to at least one processor, wherein the at least one processor is further configured to:
receive, from a communications interface of a Service Based Management Architecture (SBMA), an ML model loading request from a Management Service (MnS) Consumer;
identify an ML model loading policy defining an ML model and a target inference function to which the ML model is to be loaded;
instantiate an ML model loading process to load the ML model to the target inference function, the ML model loading process comprising a progress status attribute indicative of a progress of loading the ML model to the target inference function; and
create a Managed Object Instance (MOI) of the ML model under an MOI of the target inference function based on completion of the loading of the ML model to the target inference function.

14. The network node of claim 13, wherein the ML model loading policy further defines a second target inference function to which the ML model is to be loaded.

15. The network node of claim 14, further comprising creating a second MOI of the ML model under an MOI of the second target inference function based on completion of the loading of the ML model to the second target inference function.

16. The network node of claim 13, wherein the ML model loading request defines the ML model to be loaded.

17. The network node of claim 13, wherein the ML model loading policy further defines a condition for training the ML model.
